(19) United States
(12) Patent Application Publication
(10) Pub. No.: US 2026/0170897 A1
(43) Pub. Date: Jun. 18, 2026

(54) Method and system for performing computer-implemented game

(71) Applicant: Games Global Operations Limited, Douglas (IM)

(72) Inventors: Sebastian Klem Perrier Perez, Montevideo (UY); Sebastian Eduardo Cuneo, Buenos Aires (AR); Juan Pablo Córdoba López, Buenos Aires (AR); Guido Giussani, Buenos Aires (AR)

(21) Appl. No.: 18/985,790

(22) Filed: Dec. 18, 2024

(51) Int. Cl. G07F 17/32

(52) U.S. Cl. CPC G07F 17/3213; G07F 17/3258; G07F 17/3267

(57) ABSTRACT

A method comprising displaying a virtual game board (VGB) including a grid with multiple cells and indexed cell positions. Each cell is adapted to display a symbol corresponding to a cell state. A data structure is initiated to contain initial game data for a round of a game. Multiple drawings using an RNG are performed to determine tokens and token-type quantities, and cell positions for placement of a quantity of symbols equal to the tokens quantity. The method includes performing first and second token-type quantities of drawings to determine new states of at least some cells. Modified data based on the multiple drawings and the new states of at least some of the multiple cells is generated. The modified data indicates a set of symbols and corresponding cell positions where to display the set of symbols for the game. The method includes outputting an animation and providing a board payout.

### FIELD

This disclosure relates to a computer-implemented game.

### BACKGROUND

U.S. Pat. No. 3,663,020 is directed to a bingo game board built up on a relatively stiff back board, the front face of which is imprinted with game numerals arranged in vertical columns and horizontal rows. A middle window of a middle row of windows has no numeral and is usually designated as a “free” window, and is usually covered in some way by the player at the beginning of each game. On the described bingo game board, a fixed tab was designed to cover the middle or “free” window.

United States Patent Application Publication No. 2006/01606603 is directed to a video bingo game that combines multi-card bingo play with spinning reels with fruit or other symbols. In such games, drawn numbers (“balls”) are revealed one-at-a-time and displayed one after another. If a bingo win pattern is accomplished before a certain number of the drawn numerals are drawn, a prize is given.

United States Patent Application Publication No. 2024/0119801 is directed to a gaming machine, a method of providing a game, and program. That publication describes arrangement of a symbol in each of the plurality of cells is determined by using a virtual reel strip for displaying a virtual reel.

Despite such advances, there is a continuing need to improve how a computing system performs a computer-implemented game.

### OVERVIEW

The present application discloses embodiments including and/or related to methods, computing systems, and computer-readable memories that provide improvements in performing a computer-implemented game.

In a first aspect, a method is provided. The method comprises outputting a virtual game board on a display. The virtual game board includes a grid with multiple cells indexed to respective cell positions within the grid. Each cell is adapted to display a symbol corresponding to a state of the cell determined for a round of the game. The method also includes initiating, within a computer-readable memory, a data structure to contain initial game data for the round of the game to be displayed on the virtual game board. The method further includes performing multiple drawings using a random number generator to determine a tokens quantity, a first token-type quantity, a second token-type quantity, and cell positions within the grid for placement of a quantity of symbols equal to the tokens quantity. The method also includes performing the first token-type quantity of drawings and the second token-type quantity of drawings to determine new states of at least some of the multiple cells. Additionally, the method includes generating, within the data structure, modified data corresponding to the round of the game based on the multiple drawings and the new states of at least some of the multiple cells. The modified data indicates a set of symbols and corresponding cell positions where to display the set of symbols during performance of the round of the game. Further, the method includes determining a board payout based on the modified data. Furthermore, the method includes outputting, within the virtual game board on the display, an animation representing a respective reel spinning in at least some of the multiple cells until the respective reel stops to display the symbol corresponding to the state of the cell determined for the round of the game. Furthermore still, the method includes providing the board payout.

In a second aspect, a computing system is provided. The computing system includes one or more processors and non-transitory computer-readable memory comprising executable instructions. Execution of the executable instructions by the one or more processors causes the computing system to perform functions. The functions comprise outputting a virtual game board on a display. The virtual game board includes a grid with multiple cells indexed to respective cell positions within the grid. Each cell is adapted to display a symbol corresponding to a state of the cell determined for a round of the game. The functions also includes initiating, within a computer-readable memory, a data structure to contain initial game data for the round of the game to be displayed on the virtual game board. The functions further include performing multiple drawings using a random number generator to determine a tokens quantity, a first token-type quantity, a second token-type quantity, and cell positions within the grid for placement of a quantity of symbols equal to the tokens quantity. The functions also include performing the first token-type quantity of drawings and the second token-type quantity of drawings to determine new states of at least some of the multiple cells. Additionally, the functions include generating, within the data structure, modified data corresponding to the round of the game based on the multiple drawings and the new states of at least some of the multiple cells. The modified data indicates a set of symbols and corresponding cell positions where to display the set of symbols during performance of the round of the game. Further, the functions include determining a board payout based on the modified data. Furthermore, the functions include outputting, within the virtual game board on the display, an animation representing a respective reel spinning in at least some of the multiple cells until the respective reel stops to display the symbol corresponding to the state of the cell determined for the round of the game. Furthermore still, the functions include providing the board payout.

In a third aspect, a non-transitory computer-readable medium is provided. The non-transitory computer-readable medium comprises instructions that, when executed by one or more processors, cause a computing system to perform functions. The functions comprise outputting a virtual game board on a display. The virtual game board includes a grid with multiple cells indexed to respective cell positions within the grid. Each cell is adapted to display a symbol corresponding to a state of the cell determined for a round of the game. The functions also includes initiating, within a computer-readable memory, a data structure to contain initial game data for the round of the game to be displayed on the virtual game board. The functions further include performing multiple drawings using a random number generator to determine a tokens quantity, a first token-type quantity, a second token-type quantity, and cell positions within the grid for placement of a quantity of symbols equal to the tokens quantity. The functions also include performing the first token-type quantity of drawings and the second token-type quantity of drawings to determine new states of at least some of the multiple cells. Additionally, the functions include generating, within the data structure, modified data corresponding to the round of the game based on the multiple drawings and the new states of at least some of the multiple cells. The modified data indicates a set of symbols and corresponding cell positions where to display the set of symbols during performance of the round of the game. Further, the functions include determining a board payout based on the modified data. Furthermore, the functions include outputting, within the virtual game board on the display, an animation representing a respective reel spinning in at least some of the multiple cells until the respective reel stops to display the symbol corresponding to the state of the cell determined for the round of the game. Furthermore still, the functions include providing the board payout.

These aspects, as well as other embodiments, aspects, advantages, and alternatives will become apparent to those of ordinary skill in the art by reading the following detailed description, with reference where appropriate to the accompanying drawings. Further, this overview and other descriptions and figures provided herein are intended to illustrate embodiments using examples only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

The above, as well as additional, features will be better understood through the following illustrative and non-limiting detailed description of example embodiments, with reference to the appended drawings.

FIG. 1 is a block diagram of a machine, in accordance with the example embodiments.

FIG. 2 is a block diagram of a computing system, in accordance with the example embodiments.

FIG. 3 is a block diagram of a distributed computing system including two individual computing systems connected to one another via a computer network, in accordance with the example embodiments.

FIG. 4 and FIG. 5 show data that can be stored in a memory in accordance with the example embodiments.

FIG. 6 shows a set of modules in accordance with the example embodiments.

FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, and FIG. 21 are views of a graphical user interface in accordance with the example embodiments.

FIG. 22A and FIG. 22B show a set of functions in accordance with the example embodiments.

FIG. 23, FIG. 24, FIG. 25, and FIG. 26 each show a set of functions in accordance with the example embodiments.

FIG. 27A and FIG. 27B show a set of functions in accordance with the example embodiments.

All the figures are schematic, not necessarily to scale, and generally only show parts which are necessary to explain example embodiments, wherein other parts can be omitted or merely suggested.

### DETAILED DESCRIPTION

### I. Introduction

In this detailed description, several example embodiments are disclosed including, but not limited to, embodiments pertaining to performing aspects of a computer-implemented game (e.g., a digital, electronic game) that use a grid (e.g., a game board) to show progress of performing and completing the game. Unlike a bingo game card with numbers fixed to squares on the card, a variety of symbols, such as intermediate and final symbols (e.g., numerical coin and wild symbols), can be determined at run time and displayed within a grid as part of and/or after playing an animation.

Additionally, several example embodiments are disclosed including, but not limited to, embodiments pertaining to performing aspects of the game using a computing system (e.g., a server and/or a client computing system), a user device and/or a machine. The user device and/or the machine can be configured as and/or include a computing system. For purposes of this description, unless the context dictates otherwise, a user device or machine can include and/or be embodied as a computing system.

Throughout this description, the articles “a” or “an” are used to introduce elements of the example embodiments. Any reference to “a” or “an” refers to “at least one” or “one or more,” and any reference to “the” refers to “the at least one” or “the one or more,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures can be used in combination with one another. Thus, the figures should be generally viewed as component aspects of one or more overall embodiments, with the understanding that not all illustrated features are necessary for each embodiment.

The systems, methods, and apparatus described in this description can carry out aspects of an outcome event that includes displaying symbols. These aspects can be incorporated into outcome events, in particular, outcome events performed in response to a payment. In one aspect, the systems, methods, and apparatus provide features that can enhance traditional outcome events (e.g., slot machines or other reel-type outcome events) by providing a user with additional opportunities to win the outcome event, thereby increasing the user's interest, anticipation, and excitement in connection with the outcome event. This can in turn benefit a casino or another entity that provides an outcome event with this feature. Indeed, outcome events are typically configured to have odds that favor the casino (sometimes referred to as the “house”). Accordingly, based on the law of averages, casinos often increase their profits simply by getting more users to use its computing system to perform more outcome events. Due to the provided features, users can be drawn in (e.g., from competing casinos that lack outcome events with such features), and they can play the outcome event often. The features can include data communications between a server computing system and a client computing system within a server-client based configuration.

### II. Example Architecture

### A. Example Machine

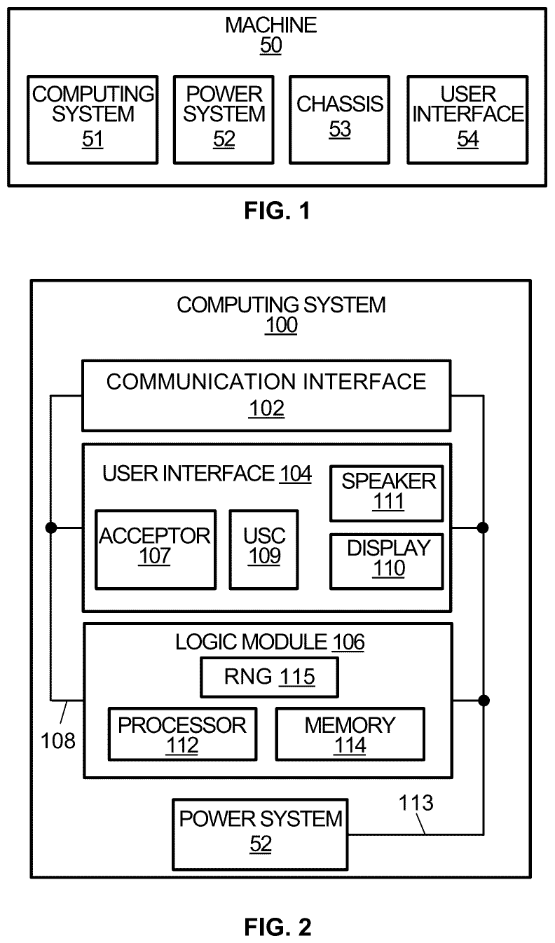

FIG. 1 is a block diagram of a machine 50 in accordance with the example embodiments. The machine 50 includes a computing system 51, a power system 52, a chassis 53, and/or a user interface 54. The machine 50 can be configured to perform a method or at least some or all functions of a method according to the example embodiments. In at least some embodiments, the computing system 51 includes at least a portion of one or more from among: the power system 52, the chassis 53, or the user interface 54.

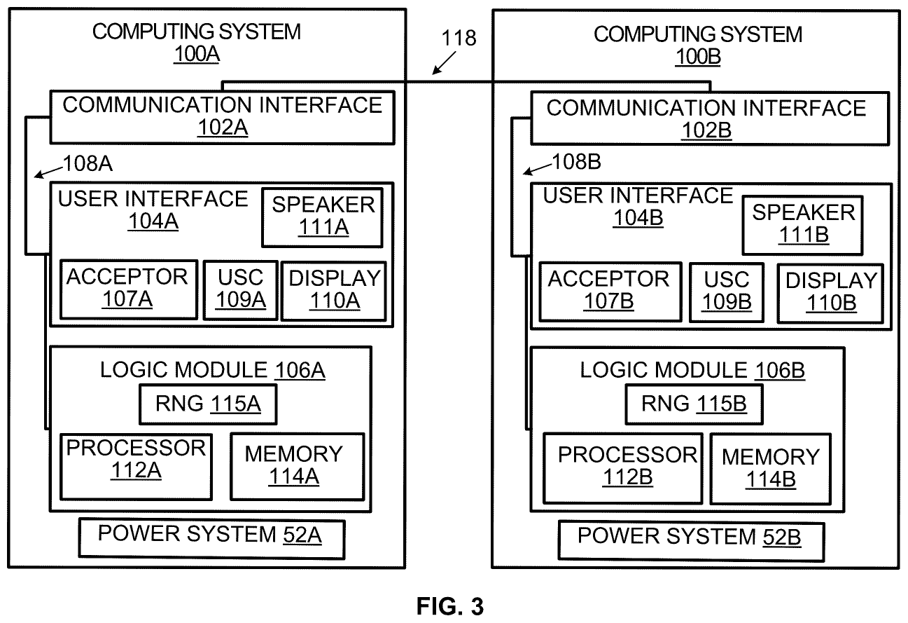

The computing system 51 can include a processor and a memory storing program instructions executable by the processor to perform a method or at least some functions of a method according to the example embodiments. As an example, the computing system 51 can be arranged as and/or include components of any computing system described in this description and/or shown in the drawings. In particular, the computing system 51 can be arranged as and/or include components of a computing system 100 shown in FIG. 2, a computing system 100A shown in FIG. 3, or a computing system 100B also shown in FIG. 3.

The power system 52 includes means for powering one or more aspects of the machine 50, such as the computing system 51, the chassis 53, the user interface 54, and/or some other computing system, such as another computing system described in this description. The power system 52 can include a power supply, such as a battery, a generator, a fuel cell, or a solar cell, and/or some other type of power supply. The power system 52 can include a power circuit (e.g., one or more power circuits) for distributing electrical power throughout the machine 50 where needed. The power system 52 can include a connector and/or connection for connecting to another power system, such as a power system within a building and/or a power system of an electrical utility company.

The chassis 53 includes means for supporting and/or protecting other aspects of the machine 50. As an example, the chassis 53 can include a rack for supporting at least portions of the computing system 51, the power system 52, and/or the user interface 54. As another example, the chassis 53 can include a housing in which at least portions of the computing system 51, the power system 52, and/or the user interface 54 reside. The chassis 53 can include a smart phone or tablet case configured for supporting components within the smart phone or tablet chassis. The chassis 53 can include one or more cooling fans. The chassis 53 can include a set of casters configured for easier movement of the machine 50.

The user interface 54 can include one or more user interface input components configured to receive and/or produce content (e.g., a signal, data, and/or information) based on some action of a user. That content can be provided to the computing system 51. The user interface 54 can include one or more user interface output components for outputting content. That content can be provided by the computing system 51 or another computing system, such as a server computing system. The user action can occur by use of the user interface 54. As an example, the user interface 54 can include a display operable to output content for viewing by a user. The output content can include an animation, a symbol, a grid, a GUI, a virtual game board, a user-selectable control, an indicator, an outcome of an instance of performing a game and/or some other content.

In at least some embodiments, the user interface 54 includes a mechanical user interface input component, such as an arm, handle or lever located on the chassis 53 similar to an arm, handle, or lever located on a mechanical slot machine. As an example, the mechanical user interface input component can be configured to input a spin request to the computing system 51. In accordance with at least some embodiments, the mechanical user interface component includes a hardware button, keypad key or switch.

In at least some embodiments, the user interface 54 includes an acceptor, such as a paper money acceptor, a coin acceptor, a token acceptor, a validator, and/or a card reader (e.g., a credit or debit card reader). In at least some embodiments, the user interface 54 includes a touch screen display operable as a user interface input component and a user interface output component.

In at least some embodiments, the computing system 51 includes at least a portion of the user interface 54. As an example, in embodiments in which the computing system 51 is arranged like the computing system 100, the computing system 100A, or the computing system 100B, the user interface 54 can be arranged like the user interface 104, the user interface 104A, or the user interface 104B, respectively.

### B. Example Computing Systems

Next, FIG. 2 is a block diagram of a computing system 100 in accordance with the example embodiments. The computing system 100 can be arranged as and/or include a stand-alone computing system, a computing platform, a remote computing platform, a distributed computing system, a personal computer, a server computing system, a client computing system, a portable computing system, a mobile phone, a smartphone, a tablet device, or some other computing device. The computing system 100 can be referred to as a user device, a casino gaming station, a client, a server or by some other term.

The computing system 100 can include a communication interface 102, a user interface 104, and a logic module 106, two or more which can be coupled together by a system bus, network, or other connection mechanism 108. The communication interface 102 can include a wired or wireless network communication interface. For purposes of this description, any content (e.g., data) described as being provided, sent, or transmitted by the computing system 100 can include content sent by the communication interface 102 over a communication network. In addition, for purposes of this description, any content described as being received by the computing system 100 can include content sent to communication interface 102 over a communication network (e.g., a communication network 118 shown in FIG. 3).

The computing system 100 can include the power system 52. A power circuit 113 can connect the power system 52 to the communication interface 102, the user interface 104, and/or the logic module 106. The power circuit 113 can connect to components of the communication interface 102, the user interface 104, and/or the logic module 106.

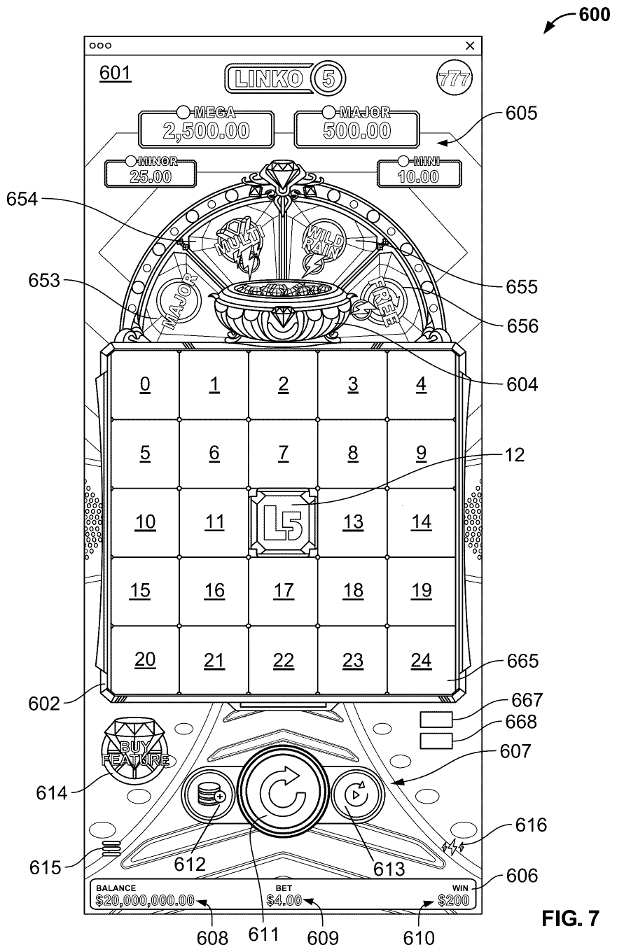

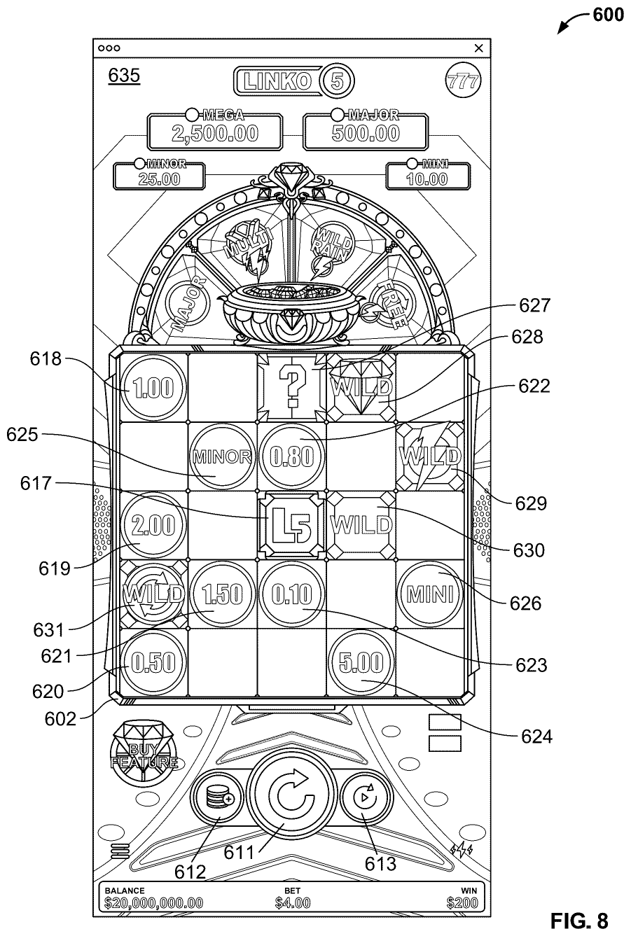

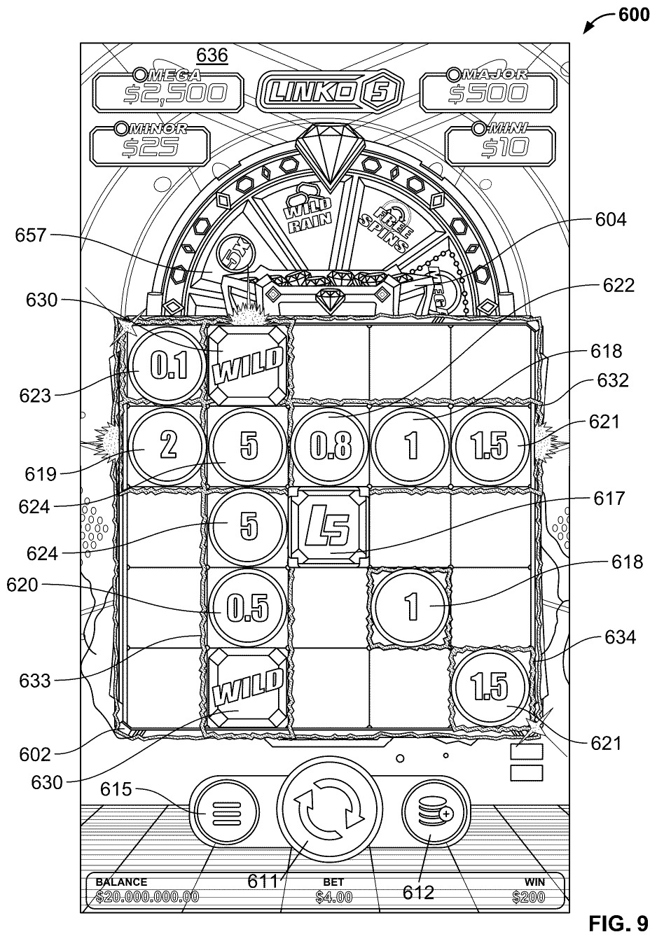

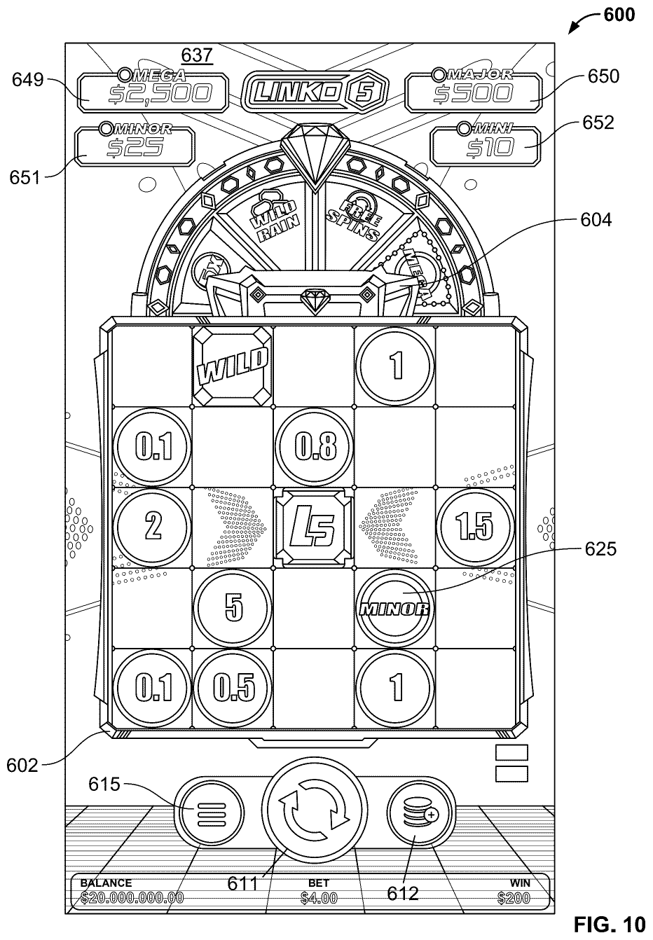

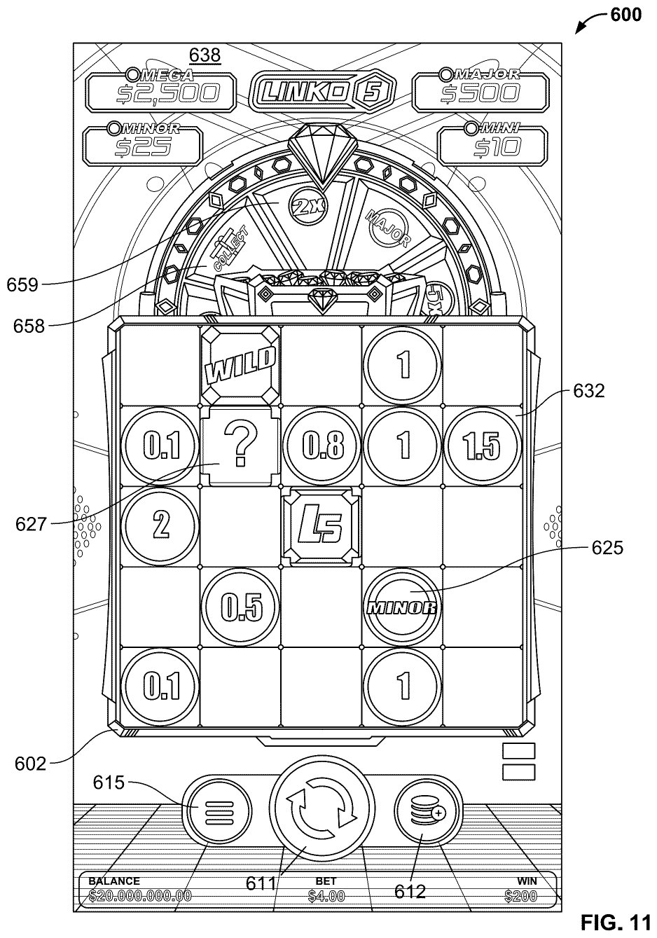

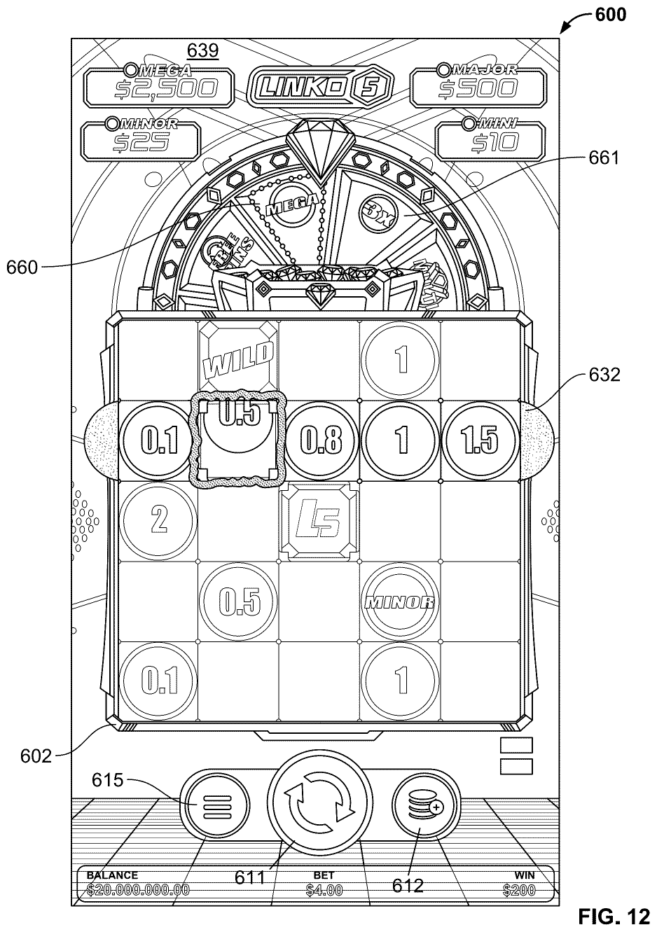

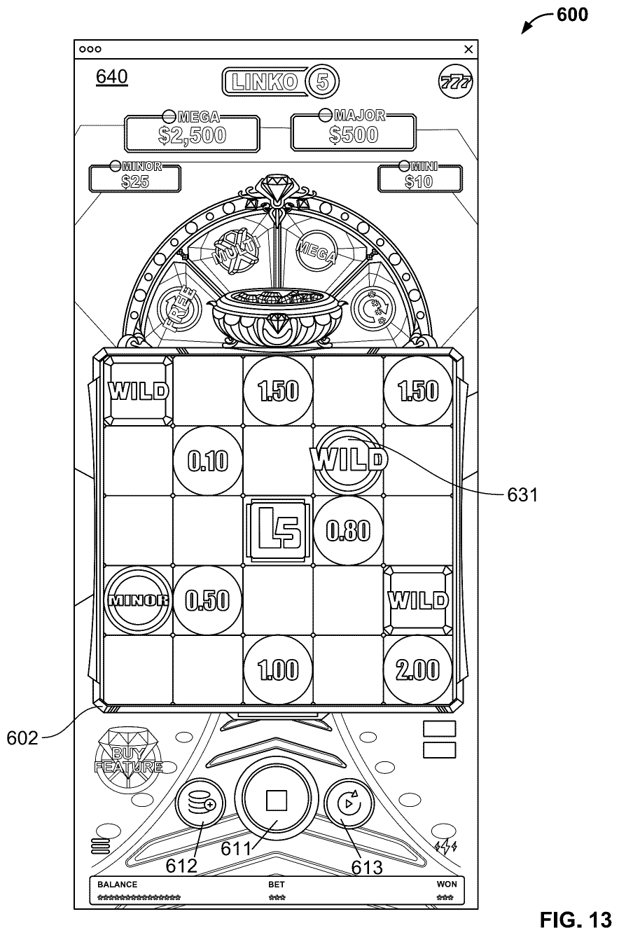

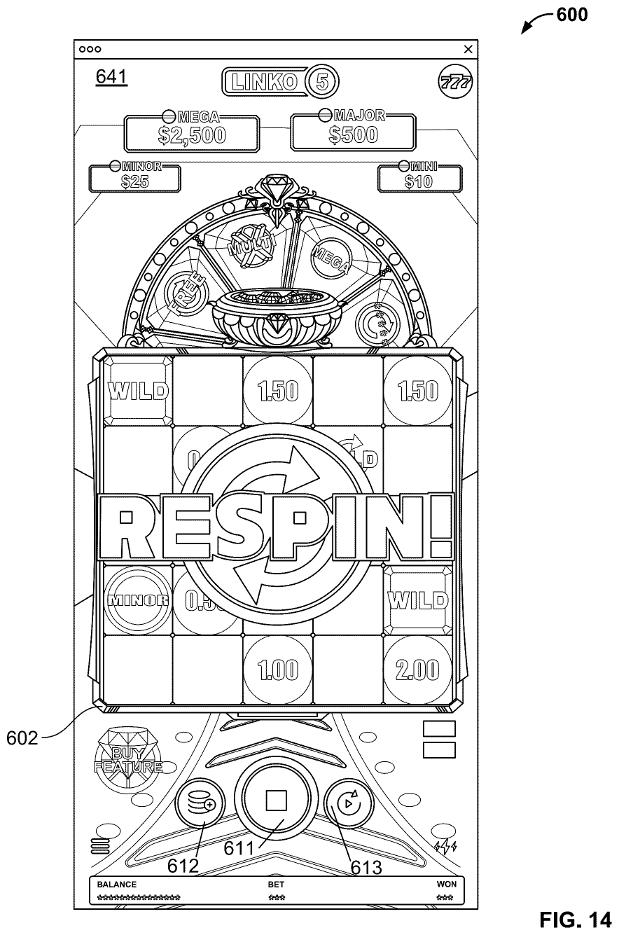

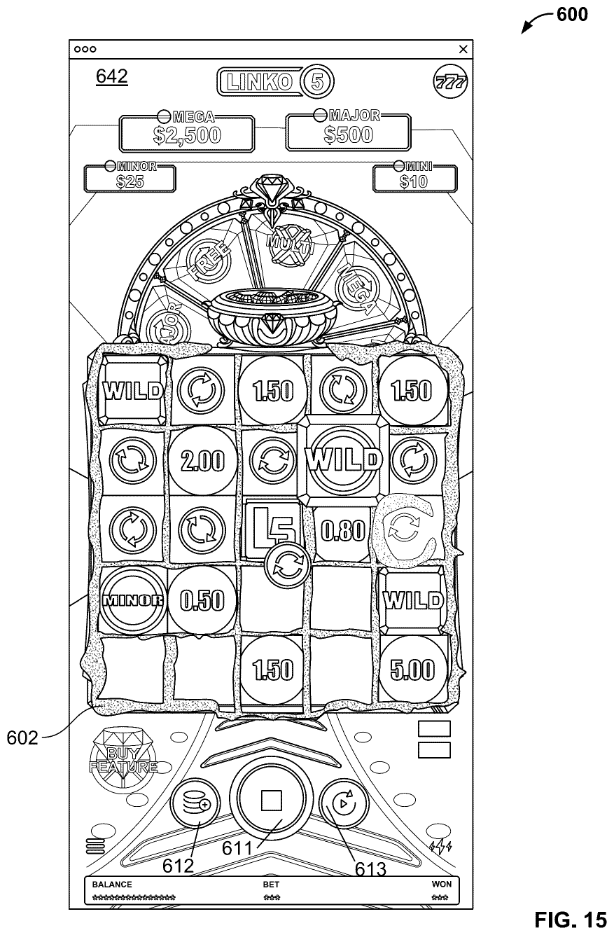

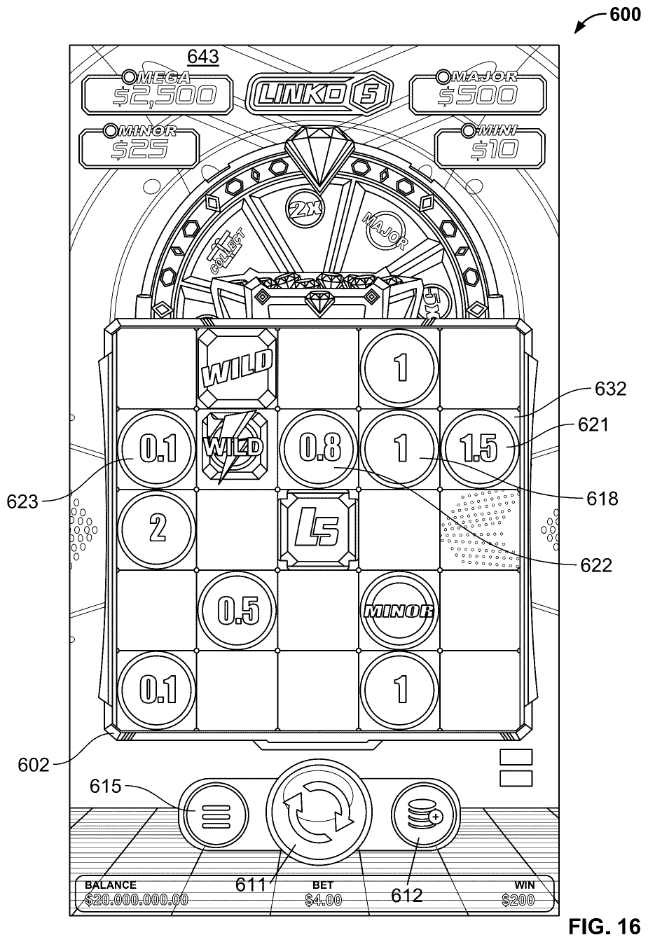

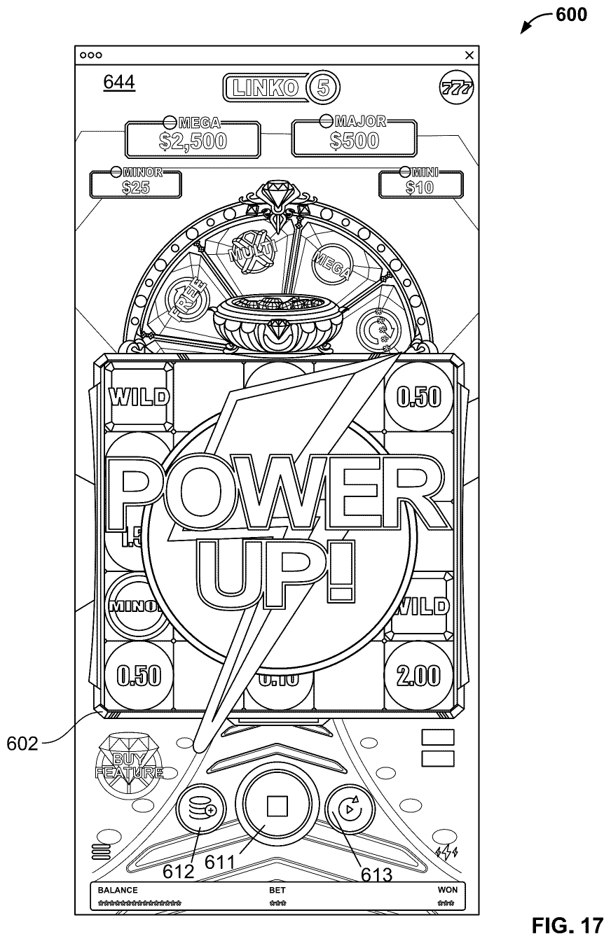

The user interface 104 includes components that can facilitate interaction with a user of the computing system 100. For example, the user interface 104 can include user interface output components, such as a display 110 and/or a speaker 111. As another example, the user interface 104 can include user interface input components, such as an acceptor 107, a user-selectable control 109 (e.g., a button, a keypad key, a keyboard, or a mouse), or a touch-sensitive screen. The touch-sensitive screen can be part of the display 110, such that the display 110 is operable as both a user interface input component and a user interface output component. The user-selectable control 109 can include one or more user-selectable controls, one or more of which can be implemented on the touch sensitive screen (which can also be referred to as a touch pad or touch screen). As an example, the user-selectable control 109 can include a spin USC 611, a bet USC 612, an auto-play USC 613, a buy feature USC 614, and/or a menu USC 615 shown in FIG. 7 and other drawings.

The display 110 is configured to display (i.e., visually present and/or show) content. As an example, the content can correspond to an outcome of performing an instance of a game, such as a set of symbols selected for the outcome event, a jackpot value, a token, a grid, a reel, a rotatable wheel, a payline, a payway, an award, an instruction, or a user-selectable control (e.g., a button). As another example, the content can include text, a graphic, a GUI, an animation, a video, or some other content as well or instead. As yet another example, the content can include content shown in and/or described with respect to any drawing. The display 110 can include a display screen (e.g., a display panel or a graphical display unit) including a quantity of pixels (e.g., 786,432 pixels in an array of pixels that is 1,024 pixels by 768 pixels). Other examples of an array of pixels are possible.

Additionally, the display 110 and/or the display screen can include and/or be arranged as a liquid crystal display (LCD), a light emitting diode (LED) display, an organic LED (OLED) display, a plasma display or some other type of display. Furthermore, the display 110 can embody the touch sensitive screen noted above such that the display 110 and/or display screen includes and/or is arranged as a touch screen display. As an example, the touch screen display can include and/or be arranged as a capacitive touch screen display or a resistive touch screen display.

The logic module 106 can include and/or be arranged as a processor 112, a memory 114, and or a random number generator (RNG) 115. The processor 112 can include a general-purpose processor (e.g., a microprocessor) or a special-purpose processor (e.g., a graphics process, a digital signal processor or an application specific integrated circuit) and can be integrated in whole or in part with the at least a portion of the communication interface 102 and/or at least a portion of the user interface 104. Any memory discussed in this description or shown in the drawings can be referred to as a computer-readable memory, data storage, computer-readable data storage, among other names. The logic module 106, the processor 112, and/or the memory 114 can include computer-readable programming instructions (CRPI). The CRPI can be referred to as machine-readable instructions. The CRPI (i.e., the machine-readable instructions) can include one or more instruction modules. The instruction modules can include computer program modules. The instruction modules can include one or more modules described throughout this description or some other module.

An RNG, such as the RNG 115 or any other RNG described in this description, can include one or more RNGs. An RNG can determine random numbers using a pseudo-random process. The processor 112 can request result(s) from the RNG 115. The result(s) can be stored in the memory 114.

In at least some embodiments, the processor 112 can request result(s) from the RNG in response to a selection of a USC (e.g., the spin USC 611 or the auto-play USC 613 shown in FIG. 7). Each result can include a random number, such as a 64-bit random number or a random number with a different quantity of bits. As an example, a result from an RNG can indicate a number corresponding to a cell identifier, such as a cell identifier with the set of cell identifier ranging from 0 to 24. In at least some embodiments, the results for an instance of the game can include multiple results from the RNG 115. A cell identifier can be referred to as a cell index. Multiple cell identifiers, as well as multiple cell indexes, can be referred to multiple cell indices or cell indices.

The memory 114 can include volatile or non-volatile storage components and can be integrated in whole or in part with the processor 112. The memory 114 can take the form of a non-transitory computer-readable medium and can include software program instructions (i.e., machine-readable instructions), that when executed by the processor 112, cause the computing system 100 to perform one or more of the functions described herein. Any software program instructions discussed in this description or shown in the drawings can be referred to as computer-readable program instructions, or more simply, program instructions, or a software application. A set of program instructions (e.g., a portion of a software application) can be referred to as a module or a logic module.

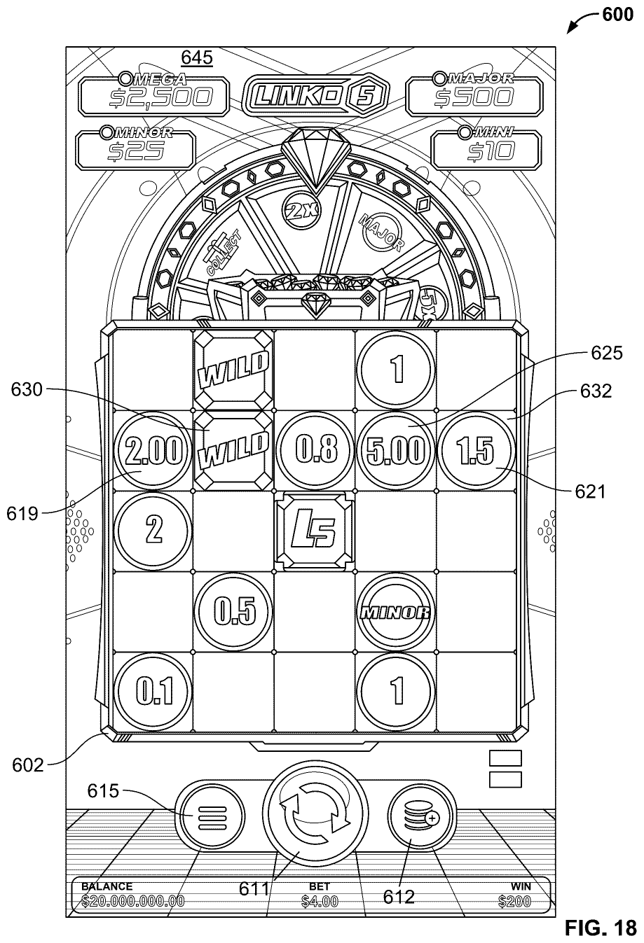

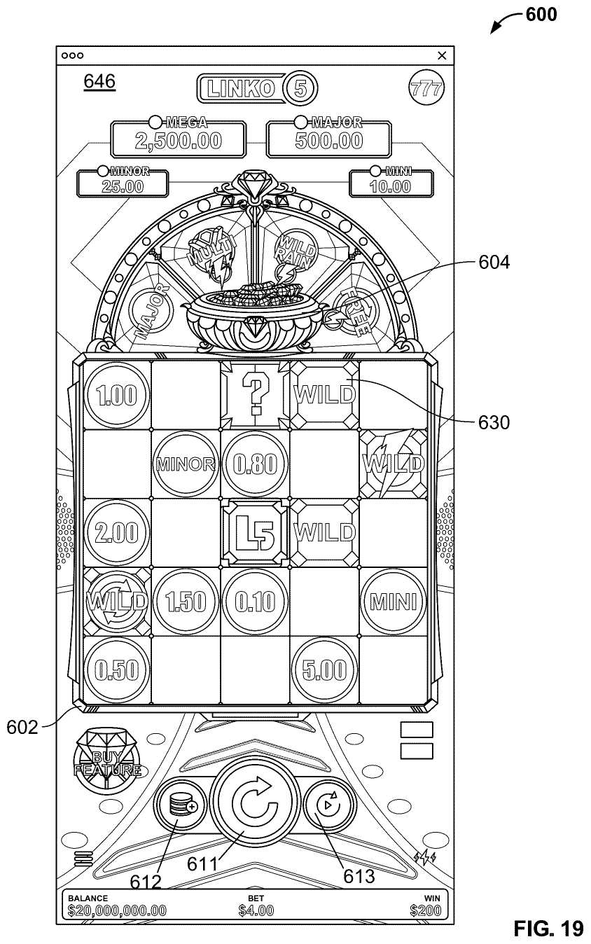

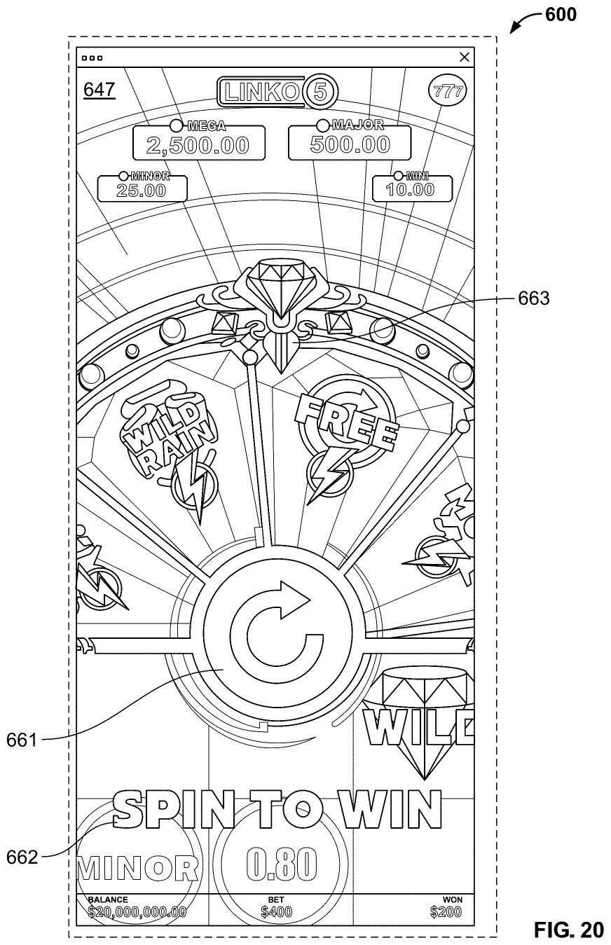

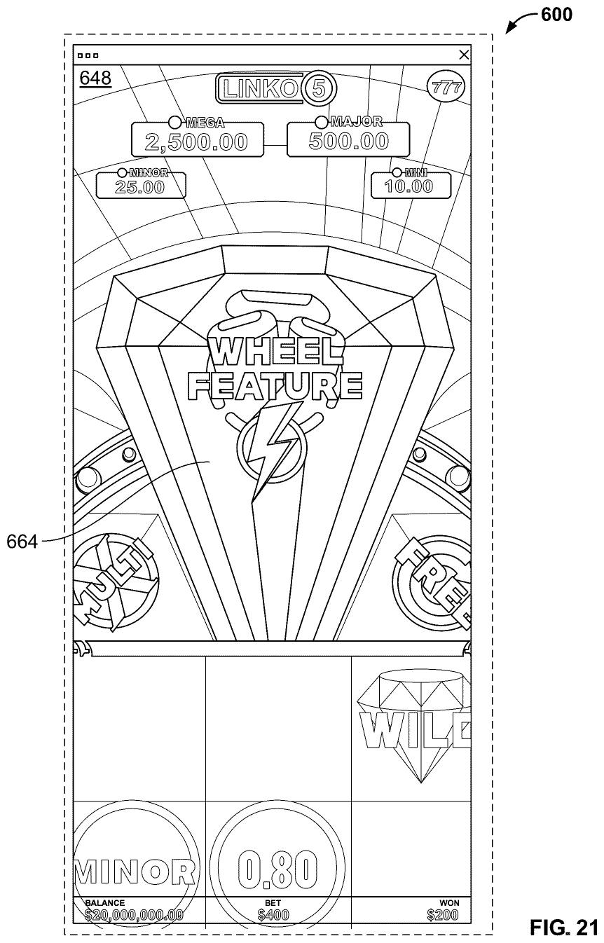

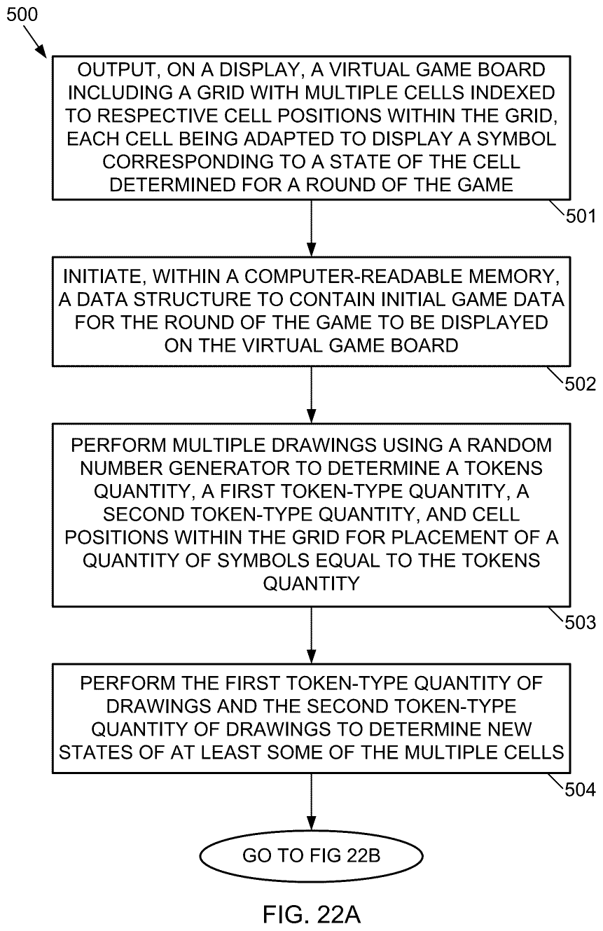

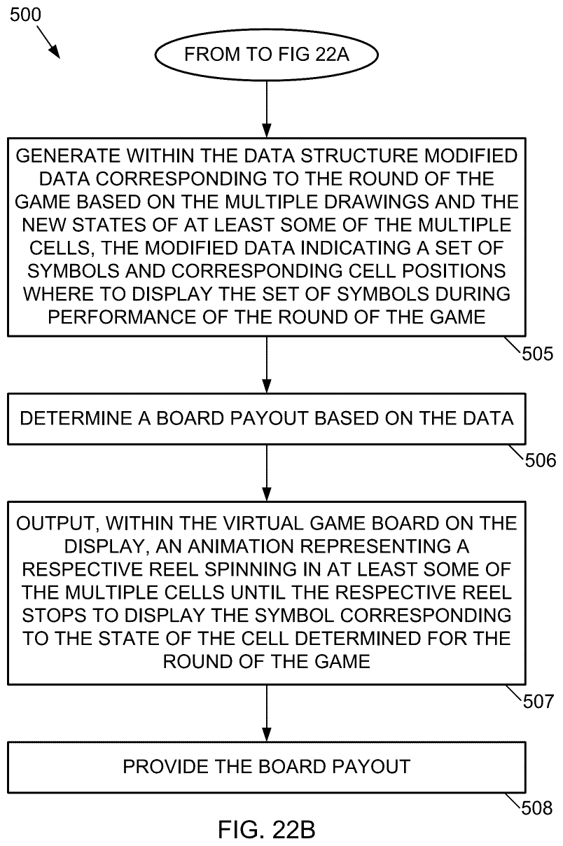

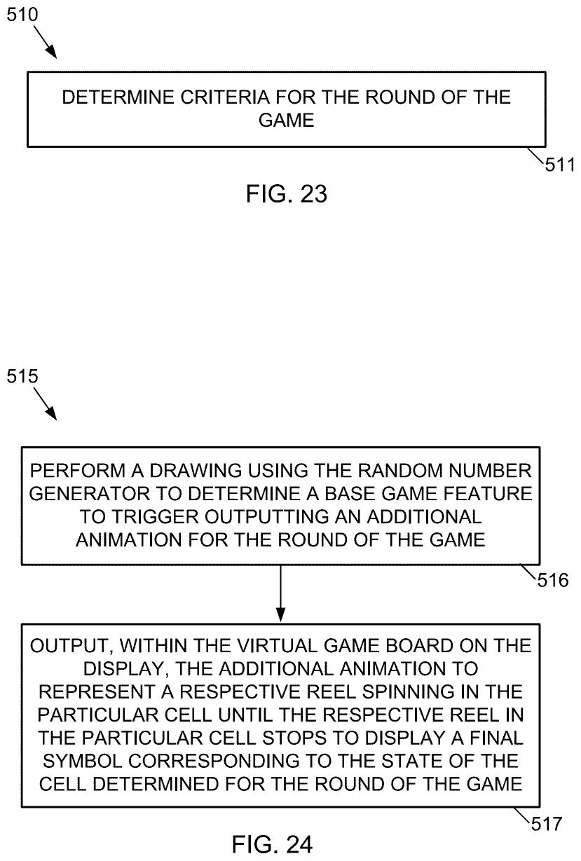

As an example, the program instructions can be executable by the processor 112 to perform a method, such as a method including one or more of the functions shown in FIG. 22A to FIG. 27B. Executing the program instructions can include executing one or more modules or portions of one or more modules.

As another example, the program instructions can be executable by the processor 112 to determine a payment has been received by the user interface 104 (e.g., by the acceptor 107) and thereafter allow an outcome to be output in response to an input entered via the user interface 104. In accordance with at least some embodiments, one or more modules can be arranged to perform an instance of the game after a processor determines a payment for that instance of the game has been received. Moreover, those modules, portions of those modules, or other modules can be arranged to perform another instance of the game after a processor determines the game is in a particular state (e.g., a free spin state or a no wager state) for that instance of the game. A computing system can operate in the game state.

The memory 114 can also include operating system software on which the computing system 100 can operate. For example, the computing system 100 can operate on a Windows®-based operating system available from the Microsoft® Corporation of Redmond, Wash. As another example, the computing system 100 can operate on an IPHONE® operating system available from Apple Inc., or an ANDROID® operating system available from Google LLC. Other examples of an operating system are possible.

The memory 114 can include a database. As an example, the memory 114 can include a credit account database containing data related to performing an instance of a game by a computing system, as well as adjusting account balances (e.g., quantities of credits) associated with client computing systems. The processor 112 can write data into the database and read data within the database.

Next, FIG. 3 is a block diagram of a distributed computing system. FIG. 3 shows a computing system 100A connected to a computing system 100B over a communication network 118. A configuration of elements including the computing system 100A and the computing system 100B can be referred to as a server-client based configuration, a peer-to-peer configuration, and/or some other configuration. The computing system 100B can be referred to as a “remote computing system” with respect to the computing system 100A and/or one or more other computing systems. Likewise, the computing system 100A can be referred to as a “remote computing system” with respect to the computing system 100B and/or one or more other computing systems.

The components of the computing system 100A and the computing system 100B are shown with corresponding “A” and “B” reference numerals (i.e., based on the computing system 100). For example, the computing system 100A includes a communication interface 102A, a user interface 104A (which includes an acceptor 107A, a user-selectable control 109A, a display 110A, and/or a speaker 111A), a logic module 106A (which includes a processor 112A, a memory 114A, and/or an RNG 115A), a power system 52A, and a communication bus 108A. Likewise, the computing system 100B includes a communication interface 102B, a user interface 104B (which includes an acceptor 107B, a user-selectable control 109B, a display 110B, and/or a speaker 111B), a logic module 106B (which includes a processor 112B, a memory 114B, and/or an RNG 115B), a power system 52B, and a communication bus 108B. In at least some embodiments, the acceptor 107A includes a validator, and the acceptor 107B includes a paper money acceptor, a coin acceptor, a validator, and/or a card reader. The examples corresponding to the power system 52 are applicable to the power system 52A, 52B.

The computing system 100A is configured to communicate with the computing system 100B over the communication network 118 (via the communication interface 102A and the communication interface 102B). Likewise, the computing system 100B is configured to communicate with the computing system 100A over the communication network 118. For purposes of this description, any data described as being sent or transmitted by the computing system 100A can include data sent by the communication interface 102A over the communication network 118. Similarly, any data described as being sent or transmitted by the computing system 100B can include data sent by the communication interface 102B over the communication network 118. Furthermore, for purposes of this description, any data described as being received by the computing system 100A can include data the computing system 100A receives from the communication network 118 using the communication interface 102A. Similarly, any data described as being received by the computing system 100B can include data the computing system 100B receives from the communication network 118 using the communication interface 102B.

In at least some embodiments, the communication network 118 includes a local area network (LAN), such as a LAN located at least partially within a casino. In accordance with those embodiments, multiple instances of the computing system 100B dispersed throughout the casino can communicate with the computing system 100A. In some cases, the computing system 100A can be located within the casino. In some other cases, the computing system 100A can be located away from the casino.

In another example, the communication network 118 can include a wide-area network (WAN), such as an Internet network or a network of the World Wide Web. In such a configuration, the computing system 100B can communicate with the computing system 100A via a website portal (for a virtual casino) hosted on the computing system 100A. The data described herein as being transmitted by the computing system 100A to the computing system 100B or by the computing system 100B to the computing system 100A can be transmitted as datagrams according to the user datagram protocol (UDP), the transmission control protocol (TCP), or another protocol, and/or a file (e.g., a hypertext transfer protocol file) or some other type of file or communication.

The communication network 118 can include any of a variety of network topologies and network devices. The communication network 118 can include a wireless and/or wired network topology and network devices operable on one or both of those network topologies. As an example, the communication network 118 can include a public switched telephone network, a cable network, a cellular wireless network, a wide area network (WAN), a local area network, an IEEE® 802.11 standard for wireless local area networks (wireless LAN) (which is sometimes referred to as a WI-FI® standard) (e.g., 802.11a, 802.11b, 802.11 g, 802.11n, or 802.11p), and/or a network operating according to a BLUETOOTH® standard (e.g., the BLUETOOTH® standard 5.3) developed by the Bluetooth Special Interest Group (SIG) of Kirkland, Washington.

As noted, the computing system 100 can include the acceptor 107. In at least some embodiments, the acceptor 107 includes an acceptor of a physical item associated with a monetary value, such as a paper money acceptor, a coin acceptor, or a card reader. The acceptor 107 can include a validator configured to identify the physical item, and determine whether the physical item is suitable as payment to the computing system 100. A coin acceptor can be configured to accept and identify a coin distributed by a geo-political body or a physical token generated for an organization other than a geo-political body, such as a casino. A card reader can be configured to read a bank card (e.g., a credit or debit card) or a customer card (e.g., a casino loyalty card).

In at least some embodiments, the computing system 100 can also physically dispense a corresponding award or payout (e.g., cash), or otherwise facilitate the payout (by adding funds to an electronic account associated with a customer card). Such an activity can be triggered by a cash out button either on the display 110 or elsewhere on the computing system 100 (e.g., as part of the user-selectable control 109). Additionally or alternatively to determining the payout amount, the computing system 100 can perform other actions to award the user. For instance, the computing system 100 can display an indication of a tangible prize. Other types of awards can be used as well.

For purposes of this description, a function that can be performed by the computing system 100, the computing system 100A, or the computing system 100B can be performed, at least in part, by a processor of that computing system executing program instructions, one or more modules, and/or a software application. Those program instructions and/or software application can be stored within the memory 114, 114A, or 114B, respectively. A random number described as being determined by the RNG 115 can be determined by the RNG 115A or the RNG 115B for implementations using the computing system 100A and/or the computing system 100B. Any function described in this description as being performed by an RNG can be performed by the RNG 115, the RNG 115A, or the RNG 115B.

The memory 114 or any other memory described in this description can also store data. For example, the data contained with a memory can include a global symbol group for performing an instance of a game that includes multiple symbols, such as a grid-based game with a bonus wheel feature game. The data in the memory 114 can include a configuration file including configuration data a processor uses to perform the game.

Symbols contained in the global symbol group table 300 can include wheel symbols, coin symbols, and wild symbols. Examples of those symbols are shown in FIG. 7 to FIG. 21. For instance, FIG. 7 shows an L5 symbol 617. FIG. 8 shows the following example coin symbols: including a numerical coin symbol 618, 619, 620, 621, 622, 623, 624, a minor symbol 625, a mini symbol 626, and a mystery box symbol 627. FIG. 8 shows the following example wild symbols: a diamond wild symbol 628, a power-up wild symbol 629, a normal wild symbol 630, and a respin wild symbol 631. The normal wild symbol 630 can help to complete a pay pattern, but does not have any value, similar to the L5 symbol 617. Aspects corresponding to some of the wild symbols are described with respect to the process feature module 479.

A numerical coin symbol, such as the numerical coin symbol 618, 619, 620, 621, 622, 623 can include a number to represent a monetary amount. As an example, the number can be a whole number (such as 1, 2, 5, or 10) or a decimal number (such as 1.00, 2.00, 5.00, or 10.00) or (such as 0.1, 0.10, 0.2, 0.5, 0.50, 0.8, or 0.80). For purposes of this description, numerical coin symbol representing a common monetary amount are referenced by a common reference number. The numerical coin symbol selectable during a round of the game can be based on a bet placed on the round of the game. For example, the bet indicator 609 shows a bet of $4.00 in FIG. 7. Had the bet been $8.00, the numerical coin symbols shown in cells 0, 7, 10, 16, 17, 20, and 23 in FIG. 8 could be twice the value shown in FIG. 8.

The global symbol group can be customized with particular symbols as desired. As an example, the symbols can include symbols configured for displaying within a grid cell and symbols configured for displaying within a wheel segment. As an example, symbols configured for displaying with a grid cell can be rectangular and symbols configured for displaying within a wheel segment can be triangular or substantially triangular. The symbols can include various graphics, such as graphics representing coins, monetary notes, a treasure chest, a question mark, or other things in addition to or instead of the symbols discussed above or shown in the drawings. Even more, some symbols can indicate and/or be defined as a wild symbol. The global symbol group can be represented as a table (or other data structure) stored in the memory 114. Other examples of symbols within the global symbol group are possible.

A memory can include one or more memories. For example, a memory can include the memory 114. As another example, a memory can include the memory 114A and the memory 114B. In accordance with this latter example, a memory can be arranged as a distributed memory. One or more processors can be operatively coupled to a memory. For example, the processor 112 is operatively coupled to the memory 114. As another example, the processor 112A is operatively coupled to the memory 114A, and the processor 112B is operatively coupled to the memory 114B. In accordance with this latter example, a processor can be arranged as a distributed processor and the memory is configured as distributed memory.

### C. Example Memory Content

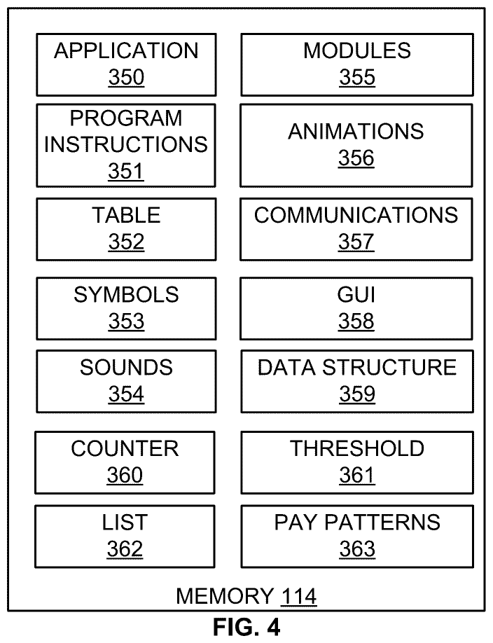

Next, FIG. 4 shows the memory 114 and data that can be stored in a memory in accordance with the example embodiments. The memory 114A and/or the memory 114B can contain some or all of the data stored in the memory 114. In at least some embodiments, at least a portion of the memory 114 is embodied as a data register or cache memory within a processor.

As shown in FIG. 4, the memory 114 can include an application 350, program instructions 351, a table 352, symbols 353, sounds 354, modules 355, animations 356, communications 357, a GUI 358, a data structure 359, a counter 360, a threshold 361, a list 362, and/or pay patterns 363.

The application 350 can include a software application, such as any software application described in this description. The application 350 can also include an operating system, such as any operating system described in this description. The application 350 can include an application programming interface (API), such as any API described in this description. As an example, the application 350 can include an application downloaded to a computing system (e.g., the computing system 100 or the computing system 100B) from an online store, such as the GOOGLE PLAY® store or the APPLE STORE® store. Such downloaded application can be launched by selecting an icon displayed on user interface of the mobile device and then executed by a processor within the mobile device to communicate with a server to allow a user of the mobile device to play the game set forth in the example embodiments.

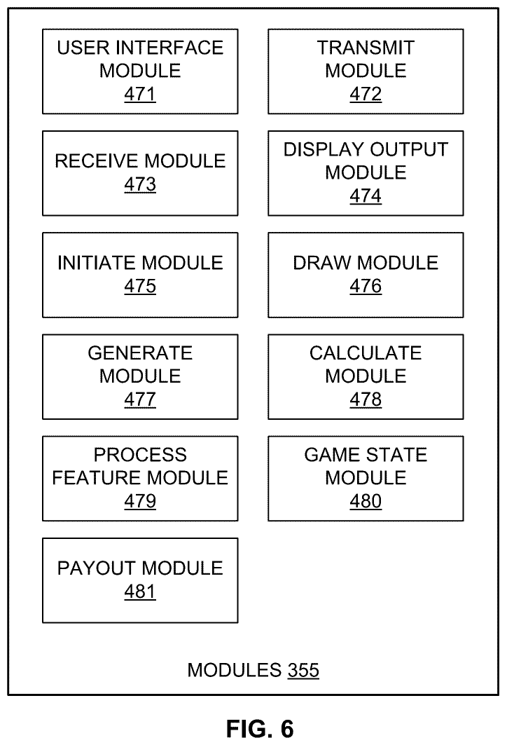

The program instructions 351 are computer-readable program instructions (i.e., machine readable instructions) executable by one or more processors. The program instructions 351 can be executable to cause a computing system or a component of the computing system to perform any function described in this description. The program instructions 351 can include the application 350. The program instructions 351 can include and/or be arranged as one or more modules, such as any module shown in FIG. 6. The application 350 can include the program instructions 351. The program instructions 351 can include and/or be arranged as an algorithm to request one or more random numbers from an RNG (e.g., the RNG 115, 115A, 115B) and apply the random number(s) to draw numbers randomly to determine grid stats, game states, game features, a wheel trigger state, an outcome for an instance of the described game, and other aspects described in this description.

The table 352 can include one or more tables, such as one or more tables shown in FIG. 4. The table 352 can include data within any table described or shown in this description. Even so, any data described as being stored in a table can be stored within the memory 114 in some manner other than a table. As an example, the memory 114 can store program instructions that include data described as being contained in a table. As another example, any data described in this description as being stored in a table can be stored in a file, such as a file of the data structure 359 or some other file.

The symbols 353 can include computer-readable data a processor can read to generate a symbol on a display, a display screen, a graphical display unit, a graphical display interface, or a GUI. As an example, the symbols 353 can include a respective computer-readable file (e.g., a bitmap file, a portable network graphics (PNG) file, a scalable vector graphics (SVG) file, a .JPG or .JPEG file) for each symbol. As another example, the symbols 353 can include a computer-readable file a processor can read to generate any symbol discussed in this description and/or shown in the drawings. A table, such as the symbol image table 301, can include an index value (e.g., a numerical identifier or a file name) corresponding to a symbol in the symbols 353.

The sounds 354 include audio files (e.g., an audio clip) that a processor (e.g., the processor 112, 112A, 112B) can output to a speaker. Outputting an audio file can include outputting a signal that produces a particular sound when the signal passes through a speaker. As an example, the particular sound can include a first particular sound to play when symbols within grid cells are spinning on a display (e.g., the display 110, 110A 110B). As another example, the particular sound can include a sound when a wheel 603 shown in FIG. 7 is spinning. The sounds 354 can include an audio file, such as an audio file with one of the following file name extensions: WAV, MP3, MP4, WMA, or some other file name extension.

Each sound in the sounds 354 can correspond to an index value such that the processor 112A can provide the processor 112B with an instruction including a particular index value so that the processor 112B outputs via the speaker 111B an audio file corresponding to the particular index value. Accordingly, the processor 112A does not have to transmit the audio file to the processor 112B each time the audio file is to be output via the speaker 111B.

The modules 355 can comprise a set of program instructions (e.g., a portion of a software application). A module is executable by one or more processors. A processor can be referred to as a logic module. One module can call for execution of another module. Execution of the called module can output data for use by the calling module. Examples of the modules 355 are shown in FIG. 6.

The animations 356 include computer-readable files displayable on a display, such as the display 110, 110A, 110B. As an example, the animations 356 can include animation files, such as an animation file with one of the following file name extensions: GIF, PNG, JPEG, SVG, or some other file name extension. One or more animations in the animation 356 can correspond to an index value such that the processor 112A can provide the processor 112B with an instruction including a particular index value so that the processor 112B outputs an animation file, corresponding to the particular index value, to the display 110B. In accordance with such embodiments, the processor 112A does not have to transmit the animation file to the processor 112B each time the animation file is to be output via the display 110B.

In at least some embodiment, an animation of the animations 356 is an animation for an entire graphical display (e.g., graphical user interface) output on display 110, 110A, 110B. In at least some other embodiments, an animation of the animations 356 is a portion of a graphical display output on display 110, 110A, 110B. Moreover, in at least some of those latter embodiments, multiple animations of the animations 356 are respective portions of a graphical display output on the display 110, 110A, 110B. As examples, first portions of a graphical display can include twenty-five separate cells within a grid 602 shown in FIG. 7, and another portion of the graphical display can include the wheel 603.

As an example, the animation displayed within two more of the cells can be the same animation. The same animation can be animation that represents a respective reel spinning within the cell. The same animation can represent the reel slowing down and then stopping. As the animation shows the reel stopping, the animation can display a transition that blends into a particular symbol that is to be displayed after the animation is played out, such as a coin symbol, an empty cell, or a wild symbol.

As another example, and again with reference to FIG. 7, an animation of the animations 356 can include an animation showing a wheel 603 spinning and then stopping with a particular wheel segment of the wheel stopped at a pointer 663. In some embodiments, the animations 356 can include a separate animation for each wheel segment such that the animation can be played out in its entirety and end with a particular wheel segment stopped at the pointer 663. In some other embodiments, an animation showing the wheel 603 spinning can be partially played out by jumping over (i.e., not playing out) portions of the animation that show the wheel 603 stopping at wheel segments other than the wheel segment that was selected to stop at the pointer 663.

As another example, the animations 356 can include instability animations, examples of which are described below with respect to FIG. 7.

The communications 357 can include one or more communications, such as a communication sent by the processor 112 or the communication interface 102, a communication generated for transmitting by the processor 112 or the communication interface 102, or a communication received by the computing system 100. For embodiments in which the communications 357 are stored in the memory 114A, the communications 357 can include a communication sent by the processor 112A or the communication interface 102A, a communication generated for transmitting by the processor 112A or the communication interface 102A, or a communication received by the computing system 100A. For embodiments in which the communications 357 are stored in the memory 114B, the communications 357 can include a communication sent by the processor 112B or the communication interface 102B, a communication generated for transmitting by the processor 112B or the communication interface 102B, or a communication received by the computing system 100B.

A processor can parse data from a communication stored in the communications 357 and write the parsed data into another part of the memory 114. A communication can include an instruction, such as an instruction including a spin request. A communication can include an index value corresponding to data stored in the receiving device so that the receiving device can determine which data is to be played out on a display. A communication can include log on and log off data corresponding to a client's use of a server. A communication can include a bet. A communication can include a result of playing the game so that the client device can display the result. Other examples of the communication are possible.

The GUI 358 includes one or more GUIs displayable on a display (e.g., the display 110, 110A, 110B). The GUI 358 can include data to populate within a GUI. A GUI within the GUI 358 can be populated with other data stored in the memory 114. For example, a GUI within the GUI 358 can be populated with a symbol of the symbols 353, a sound within the sounds 354, or an animation within the animations 356. Examples of a GUI storable within the GUI 358 are shown in FIG. 7 to FIG. 21.

The data structure 359 includes a portion of a memory and/or particular content stored within the memory 114. As an example, the portion of the memory can include a portion of the memory reserved at runtime of the application 350. The portion of the memory can include a portion of random access memory (RAM). Accordingly, the data structure 359 can be referred to as RAM. The portion of the memory can include a portion of memory reserved as heap memory. As another example, the particular content can include a file, such as data configuration file. As an example, the file can be arranged as an XML file or a JSON file. The data structure 359 can include data representing cell positions within a grid (e.g., the grid 602 shown in FIG. 7) and symbol identifiers of symbols selected to be displayed within the cell positions.

In accordance with at least some embodiments, a single configuration file in the JSON file format is used to configure all rounds of the game, for all game sessions, and for all players performing the game. Such configuration file can include data for configuring game sessions for players in different jurisdictions of different game session configurations are required in those jurisdictions. Alternatively, separate configuration files can be used to configure all game sessions in the different jurisdictions. A person having ordinary skill in the art will understand that a configuration filed can be modified as necessary for compliance with various regulations or otherwise. Examples of data within the configuration file are described throughout this description.

In accordance with at least some embodiments, the data structure 359 can include files (e.g., an XML files) storing information for respective users and each round or a session of multiple rounds of the game played by the respective user. The files can be referred to as user data files. Game stats determined by a game state module 580 shown in FIG. 6 can be written into a user data file for a particular user. When a new round of the game is initiated for that player, the processor can recover data from the user data file corresponding to the player so that the player is in the same game state when a most-prior round of the game was completed. The user data files can be stored for a particular amount of time and recovered to build a play-check of a prior round of the game if needed.

For at least some embodiments in which the computing system includes the computing system 100A and one or more instances of the computing system 100B, the configuration file can be stored within the memory 114A and used to configure rounds of a game session at the different instances of the computing system 100B without transferring the configuration file to any instance of the computing system 100B.

The counter 360 can include one or more counters. As an example, the counter 360 can include a free spin counter configured to indicate a quantity of free spins awarded during performance of a game or a quantity of how many of the awarded free spins remain to be played out. As another example, the counters can be stored within random access memory (RAM), a register of a processor, the data structure 359, or some other storage device. As another example, the counter 360 can include a counter to track a quantity of spins performed (e.g., a quantity of non-free spins performed). Other examples of a counter within the counter 360 and/or other means for storing the counter 360 are also possible.

The threshold 361 can include one or more thresholds. The application 350, the program instructions 351, and/or the modules 355 can include and/or use the threshold. As an example, the threshold 361 can include a quantity of spins threshold that must be achieved before a player is eligible to perform any or a particular buy feature selectable via the buy feature USC 614 shown in FIG. 7. In accordance with at least some embodiments, the quantity of spins threshold can be 100 spins.

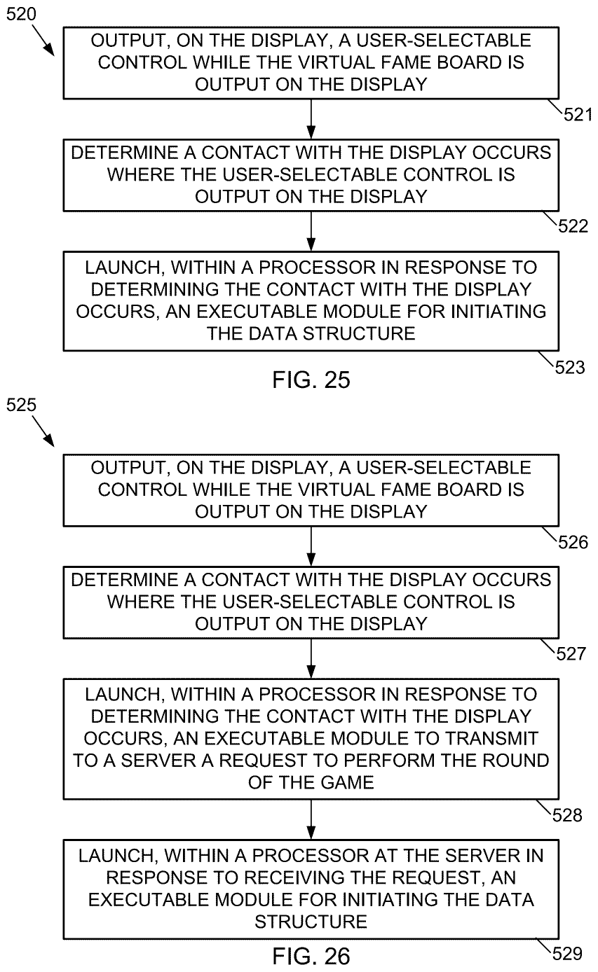

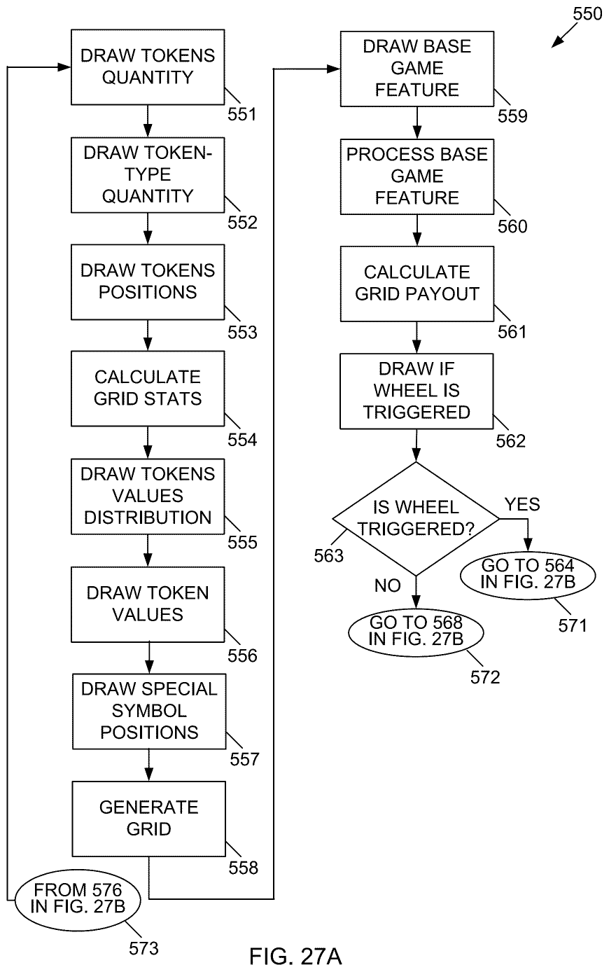

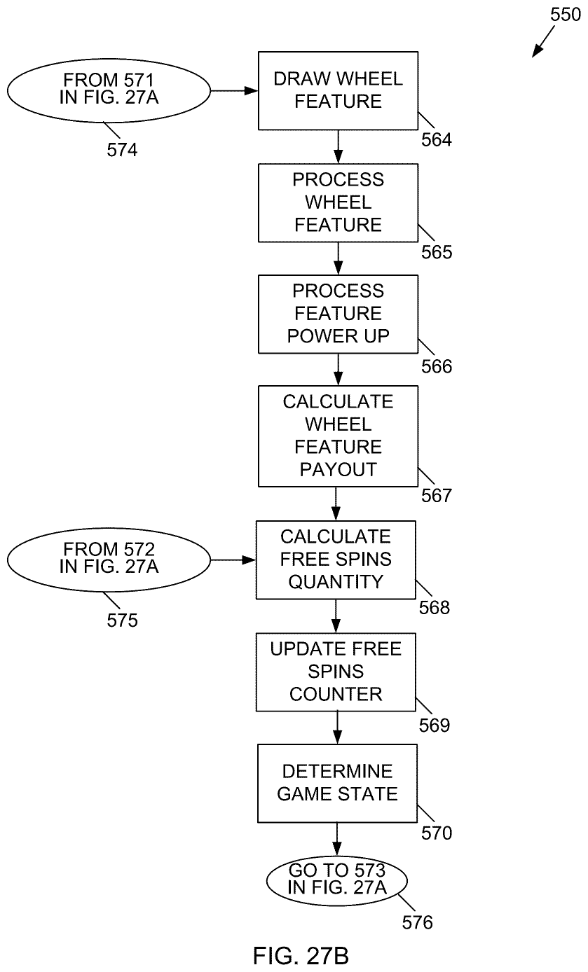

The list 362 can include one or more lists generated by a processor executing the program instructions 351 and/or one or more modules of the modules 355. As an example, the list 362 can be generated based on grid stats determined at block 554 in FIG. 27A. A length of a first list can depend on (e.g., equal) how many paying cells are to appear within a grid, and a length of a second list can depend on (e.g., equal) how many non-paying cells are to appear within a grid. As an example, the first and second lists can be generated when a processor is drawing token values (i.e., coin values) for the game.

As another example, the list 362 can include a list (e.g., a configuration model) that the draw module 476 (shown in FIG. 6) can refer to when performing drawings for a round of the game.

The pay patterns 363 include data defining pay patterns for games playable using the example embodiments. The data defining the pay patterns can indicate a state of game associated with each pay pattern (e.g., a free spin state or a paid spin state). The data defining the pay patterns can indicate cell identifiers of a grid (e.g, the grid 602) that define each respective pay pattern. A defined pay pattern can include cells of the grid on a single payline (e.g., three, four, or five cells in a single row or column of the grid 602). The pattern cells corresponding to pay pattern identifiers 0 to 4 in Table E are examples of paylines in a single row of the grid 602. The pattern cells corresponding to pay pattern identifiers 5 to 9 in Table E are examples of paylines in a single column of the grid 602.

A defined pay pattern can include cells of the grid on a single payway (e.g., three, four, or five cells in one or more rows and/or one or more columns of the grid 602). The pattern cells corresponding to pay pattern identifiers 10, 11, 13, 14 in Table E are examples of payways defined over multiple rows and columns of the grid 602. A payway based on cells in a single row or column of the grid 602 can be referred to as a payline. Accordingly, the pattern cells corresponding to pay pattern identifiers 0 to 4 in Table E are examples of payways in a single row of the grid 602 and the pattern cells corresponding to pay pattern identifiers 5 to 9 in Table E are examples of payways in a single column of the grid 602.

The data defining the pay patterns can indicate a predetermined quantity of cells within the grid (without regard to any particular arrangement of the cells in the pay pattern). For example, the data defining the pay patterns can indicate particular quantities of cells, such as 12, 13, 14, 15, 16, 17, 18, 19, 20, 21, 22, 23, 24, or 25 cells of a grid including 25 cells. As another example, the data defining the pay patterns can indicate particular quantities of cells as 12 or more cells. Other examples of quantities of cells in the predetermined quantity of cells within the grid, as well as cells with a quantity of cells other than 25, are also possible.

### D. Example Symbols

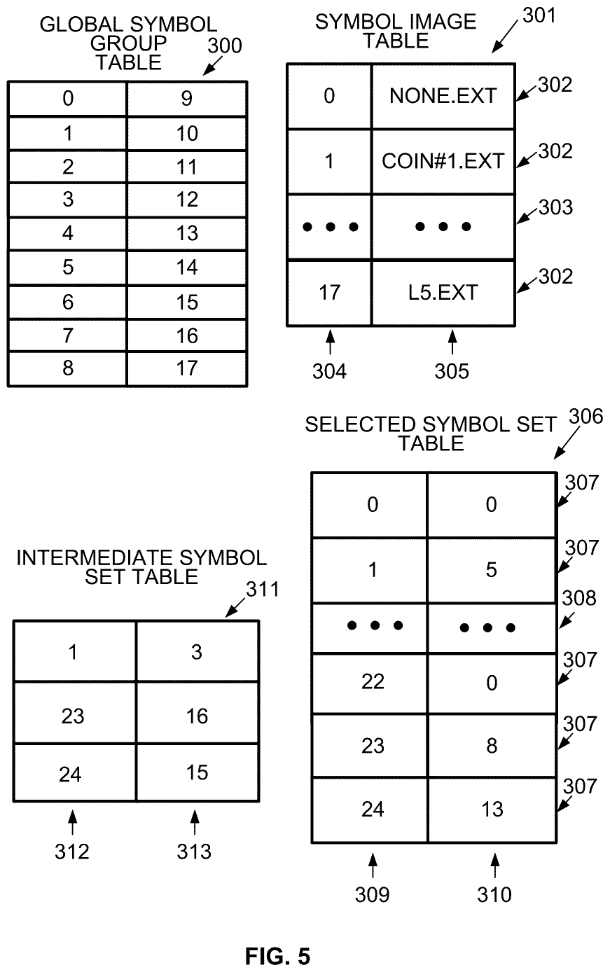

Next, FIG. 5 shows data that can be stored in a memory (e.g., the memory 114, 114A, 114B) in accordance with the example embodiments. In particular, FIG. 5 shows a global symbol group table 300 in accordance with the example embodiments. The global symbol group table 300 includes multiple records. Each record in the global symbol group table 300 can include a numeric or alpha-numeric symbol identifier that represents a particular symbol. Table A shows example symbol identifiers in the global symbol group table 300, as well as symbol type identifier, a symbol value, a symbol name, and a jackpot state corresponding to each symbol identifier. Table A also shows drawing references corresponding to some of the symbols within Table A. A configuration file stored in the data structure 359 can include configuration data including data shown in the five left-most columns in Table A. In at least some embodiments, the normal wild symbol (i.e., the symbol corresponding to symbol identifier 13) can be considered as a coin type symbol with value 0 so that the normal wild symbol can be drawn when drawing coin values (i.e., token values) as described with respect to block 556 in FIG. 27A.

TABLE A

| | | | | Jackpot | Drawing |
|---|---|---|---|---|---|
| Identifier | Type | Value | Name | (T/F) | reference |
| 0 | None | −1 | None | False | 665 |
| 1 | Coin | 0.10 | Coin#1 | False | 623 |
| 2 | Coin | 0.20 | Coin#2 | False | Null |
| 3 | Coin | 0.50 | Coin#3 | False | 620 |
| 4 | Coin | 0.80 | Coin#4 | False | 622 |
| 5 | Coin | 1.00 | Coin#5 | False | 618 |
| 6 | Coin | 1.50 | Coin#6 | False | 621 |
| 7 | Coin | 2.00 | Coin#7 | False | 619 |
| 8 | Coin | 5.00 | Coin#8 | False | 624 |
| 9 | Coin | 10.00 | Mini | True | 626 |
| 10 | Coin | 25.00 | Minor | True | 625 |
| 11 | Coin | 50.00 | Minor X2 | True | Null |
| 12 | Wild | 0 | Diamond Wild | False | 628 |
| 13 | Wild | 0 | Normal Wild | False | 623 |
| 14 | Wild | 0 | Respin Wild | False | 631 |
| 15 | Wild | 0 | Power-up Wild | False | 629 |
| 16 | Null Coin | −1 | Mystery Coin | False | 627 |
| 17 | Wild | 0 | L5 | False | 617 |

The global symbol group table 300 can be used in connection with a symbol image table 301. The symbol image table 301 includes multiple records 302 (shown as distinct rows of the symbol image table 301) and a record 303. Each record includes (in column 304) a symbol identifier that represents a particular symbol in the symbol image table 301, and (in column 305) a corresponding file name. A representative file type extension EXT is listed for each example file name in column 305. The file type extension can included a file type extension such as Joint Photographic Experts Group (JPEG), Graphics Interchange Format (GIF), Portable Network Graphics (PNG) encodings or some other file type extension. The symbol image table 301 can be used to map an identifier in the global symbol group table 300 to a file name corresponding to a displayable symbol. The record 303 represents that the symbol image table 301 can include other records configured like the records 302.

During performance of each round of the game played out on a virtual game board, various symbols can be selected for display. An identifier for each selected symbol can be stored in a table such as a selected symbol set table 306. The selected symbol set table 306 includes multiple records 307 (shown as distinct rows in selected symbol set table 306) and a record 308. Each record 307 includes a symbol position of the symbol (e.g., a grid cell) in column 309 and an identifier that represents the symbol in column 310. The record 308 represents that the selected symbol set table 306 can include other records configured like the records 307.

In accordance with at least some embodiments, one or more intermediate symbols can be selected and displayed within a cell before a final symbol selected for that cell is displayed during a given round. Cell and symbol identifiers for intermediate symbols can be stored in the data structure 359, or some portion of the data structure such as a list. That data can be stored in an intermediate symbol set table 311 or otherwise. As an example, an intermediate symbol for cell 1 can be a symbol with identifier 3 in Table A (e.g., a numerical coin symbol 620 with value 0.50), and a final symbol for cell 1 can be a symbol with identifier 5 in Table A (e.g., a numerical coin symbol 618 with value 1.00). As another example, an intermediate symbol for cell 23 can be a symbol with identifier 16 in Table A (e.g., a mystery box symbol 627), and a final symbol for cell 23 can be a symbol with identifier 8 in Table A (e.g., numerical coin symbol 624 with value 5). As yet another example, an intermediate symbol for cell 24 can be a symbol with identifier 15 in Table A (e.g., a power-up wild symbol 629), and a final symbol for cell 24 can be a symbol with identifier 13 in Table A (e.g., a normal wild symbol 630). The column 312 in the intermediate symbol set table 311 shows cell identifiers, whereas the column 313 in the intermediate symbol set table 311 shows symbol identifiers. The cell 1, 23, 24 are shown in FIG. 7.

In accordance with the example embodiments, the computing system 100 can select a symbol set for outputting in the grid 602 by iterating through each record 307, 308 in the selected symbol set table 306. As an example, for each cell identifier in the selected symbol set table 306 (i.e., each cell identifier in column 309), the processor 112 can determine a symbol identifier from among the symbol identifiers in the global symbol group table 300. In at least some embodiments, the symbol identifiers are numbers and the processor 112 uses a random number generator to determine numbers in the global symbol group table 300 to associate with each symbol position in the selected symbol set table 306. Other examples of how the computing system 100 and/or the processor 112 randomly determine symbols for the selected symbol set table 306 are also possible.

### E. Example Modules

Next, FIG. 5 shows examples of the modules 355. In particular, the examples include a user interface module 471, a transmit module 472, a receive module 473, a display output module 474, an initiate module 475, a draft module 476, a generate module 477, a calculate module 478, a process feature module 479, a game state module 480, and a payout module 481.

### 1. User Interface Module

The user interface module 471 is configured to receive inputs entered via a user interface, such as the user interface 54 shown in FIG. 1, the user interface 104 shown in FIG. 2, the user interface 104A, 104B shown in FIG. 3, or any user interface (e.g., a graphical user interface) shown in the drawings.

As an example, the user interface module 471 can be configured to receive an input signal (e.g., an analog, or digital, electrical signal indicating a user-selectable control at the user interface has been selected. As another example, the user interface module 471 can be configured to receive data entered into a data field, such as a data field indicating a user name, a password, a payment card number, an expiration date, a card verification code, or some other data.

As yet another example, a display can comprise a touch screen display and the user interface module 471 can be configured to receive an input signal indicating a contact with the display occurs where a user-selectable control is output on the display. In accordance with this example, the processor 112B can execute the user interface module 471 to receive the input signal. For instance, the user selectable control can be output within the user-selectable controls 607 shown in FIG. 7. Accordingly, the contact with the display can occur with respect to a spin USC 611, a bet USC 612, an auto-play USC 613, a buy feature USC 614, or a menu USC 615, each of which is shown in FIG. 7.

### 2. Transmit Module

The transmit module 472 is configured to transmit content away from the computing system executing the transmit module. As an example, the transmit module 472 is configured to cause the communication interface 102 to transmit content to one or more other computing systems. As another example, the transmit module 472 is configured to cause the communication interface 102A to transmit content to the computing system 100B. As yet another example, the transmit module 472 is configured to cause the communication interface 102B to transmit content to the computing system 100A. The transmitted content can include a communication of the communications 357.

### 3. Receive Module

The receive module 473 is configured to receive content transmitted to the computing system executing the receive module. As an example, the receive module 473 is configured to cause the communication interface 102 to receive content transmitted to the computing system 100 from another computing system. As another example, the receive module 473 is configured to cause the communication interface 102A to receive content transmitted to the computing system 100A from the computing system 100B. As yet another example, the receive module 473 is configured to cause the communication interface 102B to receive content transmitted to the computing system 100B from the computing system 100A. The received content can include a communication of the communications 357.

### 4. Display Output Module

The display output module 474 is configured to output content on a display. As an example, the content can include a graphical user interface via which a user at a client can input data to be sent to a server to log on to the server for playing a game. As another example, the content can include a virtual game board, such as any virtual game board discussed in this description. As yet another example, the content can include aspects displayed within the virtual game board, such as any aspects discussed in this description as being displayed or displayable on a virtual game board. As still yet another example, the content can include one or more animations, such as animations simulating reels of a virtual game board spinning and then stopping with a particular symbol landing in a cell of the virtual game board. As a further example, the content can include a graphical user interface, or any aspect of any graphical user interface, shown the application drawings. Although an animation can represent a spinning reel, the symbols available to be displayed after the spinning reel stops need not be on a reel strip (e.g., a reel of symbols or more simply, a reel).

As an example, the display output module 474 can configured to translate data defining a graphical user interface into pixels to display on the display. The data translation can include determining a position, size, color, and shape represented by the data defining the graphical user interface.

As another example, the display output module 474 can be configured to output a virtual game board including a grid with multiple cells indexed to respective cell positions within the grid. Each cell is adapted to display a symbol corresponding to a state of the cell determined for a round of the game. As an example, the grid includes a first quantity of rows and a second quantity of columns. In some embodiments, the first quantity does not equal the second quantity. In other embodiments, the first quantity equals the second quantity. In at least some of those latter embodiments, the first quantity and the second quantity both equal five, and the grid with multiple cells includes a rectangular grid and twenty-five cell positions corresponding to a respective cell position of the multiple indexed cells. As an example, the grid can include five horizontal paylines, five vertical paylines, and two diagonal paylines, each of which includes a different combination of five cell positions.

The grid output by execution of the display output module or otherwise can include symbols arranged according to one or more pay patterns. One or more of the pay patterns can include a horizontal payline, a vertical payline, a diagonal payline, a cluster of adjacent cells, a cluster of non-adjacent cells, a partially vertical and partially horizontal pattern, or at least a predetermined quantity of cells distributed throughout the grid. As an example, the horizontal payline comprises contiguous cells extending from a top of the grid to a bottom of the grid. As another example, the vertical payline comprises contiguous cells extending from a left side of the grid to a right side of the grid. As yet another example, the diagonal payline comprises contiguous cells extending from a top, left side of the grid to a bottom, right side of the grid or from a top, right side of the grid to a bottom, left side of the grid. The partially vertical and partially horizontal pattern can comprises a T-shaped pattern or an X-shaped pattern. Other examples of pay patterns are described with respect to pay patterns 363 above and elsewhere in this description.

In accordance with the example embodiments, the display output module 474 can be configured to output, within a virtual game board on a display, an animation representing a respective reel spinning in at least some of the multiple cells until the respective reel stops to display a symbol corresponding to a state of the cell determined for a round of the game. The animation can be played out even though the resulting symbol to be displayed is not on a reel.

In accordance with the example embodiments, the display output module 474 can be configured to output, within the virtual game board on the display, an additional animation to represent a respective reel spinning in a particular cell until the respective reel in the particular cell stops to display an intermediate symbol corresponding to a state of cell determined for the round of the game. As described below, the draw module 476 can be configured to determine a base game feature to trigger outputting an additional animation. The intermediate symbol can be displayed before a symbol corresponding to the state of a particular cell determined for the round of the game (e.g., a final symbol) is displayed during the round of the game.

In accordance with the example embodiments, the display output module 474 can be configured to output, within the virtual game board on the display, an additional animation to represent a respective reel spinning in a particular cell until the respective reel in the particular cell stops to display a final symbol corresponding to a state of cell determined for the round of the game. The final symbol can have a greater value than the preliminary symbol. In such case, a feature performed by execution of the draw module 476 to select the final symbol can comprise a power-up feature. In accordance with at least some embodiments, the symbols that appear after the animation is played out are not positioned on any reel (e.g., a reel strip). The symbols to be displayed can be based on drawings from a configuration file and the drawings can indicate which symbol is to be displayed after the animation is played out.

As another example, the display output module 474 can be configured to output animations to make it appear on a display that each the outcome for each cell within the grid 602 is determined independently.

In accordance with the example embodiments in which a display includes a touch screen display, the display output module 474 can be configured to output a user-selectable control on the touch screen display. As an example, the user-selectable control can be output on display along with a virtual game board. In accordance with at least some embodiments, the user-selectable control can be selectable to launch execution of a module (e.g., the transmit module 472) to transmit, to a server, a request to perform a round of the game. In accordance with at least some embodiments, the user-selectable control can be selectable to launch execution of a module (e.g., the initiate module 475) to initiate a data structure to be used for playing a game.

### 5. Initiate Module

The initiate module 475 can be configured to initiate a data structure to contain initial game data for a round of a game to be displayed on the virtual game board. The data structure can be stored within a memory, such as the memory 114 (shown in FIG. 2), the memory 114A or the memory 114B (both shown in FIG. 3), or some other computer-readable memory. The data structure provides a way for the virtual game board to persist while the game is played and to be modified to store data representing modified states of the game.

In accordance with at least some embodiments, the initiate module 475 can be configured to determine criteria from which the initiate module 475 can select at least some of the initial game data. As an example, the data structure can comprise sets of criteria from which the initial game data is selected. As an example, the criteria can include multiple criteria (e.g., first criteria and second criteria).

In accordance with at least embodiments, the data structure comprises a file, such as an extensible markup language (XML) file or a Java script object notation (JSON) file. As an example, the data structure includes a file, such as an XML or JSON file, containing user session data. As another example, the data structure includes a file, such as an XML or JSON file, containing an integer list comprising a cell index value corresponding to each cell of the multiple cells, an integer list comprising symbol identifiers corresponding to each cell index value, and a decimal list comprising a value for each cell index value. As yet another example, the data structure comprises a group of memory addresses reserved by the processor when launching an application for performing a game. The file of the data structure can be referred to as a “configuration file.”

In accordance with at least some embodiments, initiating the data structure includes setting a state for each indexed cell to an empty state. Initiating the data structure can include generating a new data structure or overwriting data in an existing data structure used for a prior round of the game. Table B shows example data of a data structure based on execution of the initiate module 475. As shown in Table B, the data structure includes a unique index value corresponding to each of twenty-five cells of a grid and state values of each of the twenty-five cells (e.g., cell 0 to cell 24 shown in FIG. 7). The state column to the immediate right of the each cell state corresponds to that cell state. The cell indices range from 0 to 24. The cell states for all cells except for cell 12 is negative one (i.e., −1) and the cell state for cell 12 is zero (i.e., 0). A cell state of −1 is represents an empty cell (e.g., a cell without any coin or wild symbol). Other examples of a number or character representative of an empty cell are possible. A cell state of 0 can represent a wild symbol, or a particular type of wild symbol, such as an L5 symbol discussed elsewhere in this description.

TABLE B

| Cell | State |
|---|---|
| 0 | −1 |
| 1 | −1 |
| 2 | −1 |
| 3 | −1 |
| 4 | −1 |
| 5 | −1 |
| 6 | −1 |
| 7 | −1 |
| 8 | −1 |
| 9 | −1 |
| 10 | −1 |
| 11 | −1 |
| 12 | 0 |
| 13 | −1 |
| 14 | −1 |
| 15 | −1 |
| 16 | −1 |
| 17 | −1 |
| 18 | −1 |
| 19 | −1 |
| 20 | −1 |
| 21 | −1 |
| 22 | −1 |
| 23 | −1 |
| 24 | −1 |

Initiating the grid with all cells having the empty state (not including cell 12) can save processing steps by not having to subsequently determine states of the cells having empty states if the states of those cells do not change based on subsequent draws. In other words, once the cells are initiated to be in the empty state, only the cells that are selected to be in a non-empty state (e.g., a coin or wild state need to have its state modified to the non-empty state.

In accordance with at least some embodiments, initiating the data structure includes setting a state for one particular indexed cell state (e.g., cell 12) to a free space state and a state for each indexed cell except for the one particular indexed cell to an empty state. As an example, the free space state can be indicated within a GUI (e.g., the GUI 600 shown in FIG. 7) with the L5 symbol.

In accordance with at least some embodiments, the data structure discussed herein can include multiple data structures (e.g., multiple data fields), such as a first data structure comprising the sets of criteria, and a second data structure in which the initial game data selected from the sets of criteria is stored.

As an example, the sets of criteria can include criteria that indicates whether the round of the game is a free round. In other words, the sets of criteria can include a first set of criteria to use if the game is a free round and a second set of criteria to use if the game is not a free round.

As another example, the sets of criteria can include a tokens quantity criteria set in which the tokens quantity indicates a quantity within a range of whole numbers greater than zero and less than a number equal to a total quantity of cells within the grid. In accordance with at least some embodiments, the total quantity of cells is greater than or equal to 9. In accordance with at least some embodiments, the total quantity of cells equals 25. In accordance with at least some embodiments, the range of whole numbers includes two or more numbers selected from a group of numbers consisting of 11, 12, 13, 14, 15, 16, and 17. In accordance with at least some of those embodiments, the two or more numbers are consecutive numbers, but in other embodiments the two or more numbers include some non-consecutive numbers.

As another example, the criteria for determining a tokens quantity can include integer values of the drawable tokens quantity and respective hits value for each drawable tokens quantity. The probability of drawing a particular tokens quantity is based on its respective hits value, the sum of all hits values minus any tokens quantities already drawn. In accordance with at least some embodiments, the criteria with respect to free spin of the fame generally has more hits attributed to the lower number of tokens quantities as compared to criteria with respect to paid spins. Table C includes example criteria for selecting a tokens quantity.

TABLE C

| | |
|---|---|
| Free spin criteria | Paid spin criteria |

| Tokens quantity | Hits | Tokens quantity | Hits |
|---|---|---|---|
| 11 | 80,000 | 11 | 1 |
| 12 | 1,000 | 12 | 3 |
| 13 | 500 | 13 | 6 |
| 14 | 500 | 14 | 3,000 |
| 15 | 500 | 15 | 3,000 |
| 16 | 11,100 | 16 | 3,000 |
| 17 | 6,225 | 17 | 850 |
| 18 | 100 | 18 | 60 |
| 19 | 35 | 19 | 40 |
| 20 | 20 | 20 | 20 |
| 21 | 12 | 21 | 10 |
| 22 | 5 | 22 | 6 |
| 23 | 2 | 23 | 3 |
| 24 | 1 | 24 | 1 |

As another example, the sets of criteria can include a pay tokens quantity set including, for example, integer values 7 to 10. As yet another example, the sets of criteria can include a pay lines quantity criteria set including, for example, the integer values 0 to 12. In accordance with at least some embodiments, a set of criteria can included weighted criterion in that the set of criteria includes more instances of one criterion than a different criterion.

As another example, initiate module 475 can be configured to determine first criteria that indicates whether the round of the game is a free round, and whether quantities of tokens available for determining by the first drawing are weighted. Determining second criteria can be conditioned on the tokens quantity determined by performing the first drawing.

In accordance with embodiments in which a display at a client computing system (e.g., the computing system 100B) comprises a touch screen display, the initiate module 475 can be launched to initiate the data structure 359 in response to a user-selectable control output on the display being contacted.

The initiate module 475 can be configured to initiate the data structure for each round of the game, such as a first round of the game ever played on a particular computing system or a round of the game played after the first round of the game ever played on the particular computing system. The round of the game played after the first round of the game can comprise a round of the game played during a single session of playing the game or in a subsequent session that occurs after a first session in which the first round of the game is played. As an example, each session of playing the game can occur during a time period in which a client is logged onto a server to play the game.

### 6. Draw Module

The draw module 476 can be configured to perform drawings with respect to performing a game, such as a game played out at least partially using a virtual game board. As an example, the draw module 476 can use a random number generator (e.g., the RNG 115, 115A, 115B) to perform the drawings.

As an example, the draw module 476 can be configured to perform multiple drawings using an RNG to determine a tokens quantity, a first token-type quantity, a second token-type quantity, and cell positions within the grid for placement of a quantity of symbols equal to the tokens quantity. In accordance with that example, the draw module 476 can be configured to perform the first token-type quantity of drawings and the second token-type quantity of drawings to determine new states of at least some of the multiple cells. The new states of at least some of the multiple cells can correspond to a token value or a type of wild symbol.

As another example, performing the multiple drawings can occur sequentially including performing a first drawing to determine the tokens quantity, then performing a second drawing to determine the first token-type quantity, and then performing a quantity of drawings equal to the tokens quantity to determine the cell positions. In accordance with this example, determining the second token-type quantity includes determining a difference between the tokens quantity and the first token-type quantity.

As another example, the draw module 476 can be configured to perform a drawing using the random number generator to determine a base game feature to trigger outputting an additional animation for the round of the game. The additional animation can be used by the display output module 474 as described above.

As yet another example, the draw module 476 can be configured to perform a drawing to determine a base game feature state selected from a group of base game feature states. That group can, for example, include a no base game feature state, a respin base game feature state, and a power-up base game feature state.

As yet another example, the draw module 476 can be configured to perform a drawing for each cell within the a grid (e.g., the grid 602) that is determined as a cell to contain a symbol other than any free cell. The RNG selection can correspond to a predetermined subset of symbols, such as subset of symbols containing coin symbols or wild symbols.

As still yet another example, the draw module 476 can be configured to perform draw functions shown in blocks 551, 552, 553, 555, 556, 557, 559, 562 shown in FIG. 27A and in block 564 shown in FIG. 27B. The draw module 476 can be configured to perform the functions described with respect to blocks 551, 552, 553, 555, 556, 557, 559, 562, 564.

### 7. Generate Module

The generate module 477 can be configured to generate data within a data structure, such as the data structure 359. The generated data can be modified data corresponding to a round of the game. Generating the data within the structure can include executing program instructions to write/overwrite data into the data structure. As an example, the program instructions can include a write ( ) instruction, a fwrite ( ) instruction, a put ( ) instruction, a memcpy ( ) instruction, a memmov ( ) instruction, a strcpy ( ) instruction or some other programming instruction that results in different data residing in the data structure than what was contained in the data structure prior to its execution.

As an example, the generate module 477 can be configured to generate, within a data structure, modified data corresponding to a round of the game based on multiple drawings and new states of at least some of the multiple cells. The modified data can indicate a set of symbols and corresponding cell positions where to display the set of symbols during performance of the round of the game.

As an example, the generate module 477 can be configured to read data determined by another module (e.g., the user interface module 471, the receive module 473, the draw module 476 the calculate module 478, the process feature module 479, the game state module 480, or the payout module 481) and write that data into the data structure 359.

### 8. Calculate Module

The calculate module 478 can be configured to calculate different aspects for performing the game. Some aspects occur before a round of the game commences, such as calculating a balance after entry of a wager, calculating a fee associated with performing a supplemental spin, or calculating a fee associated with providing the guarantee of the diamond wild symbol 628 landing.

Some aspects are calculated occur after a user has made a selection to start a round of the game, such as selection of a spin USC 611 or an auto-play USC 613 shown in FIG. 7. As an example, grid stats can be calculated based on some initial draws, such as draws described with respect to blocks 551, 552, 553 shown in FIG. 27A. As another example, a grid payout can be calculated as described with respect to block 561 shown in FIG. 27A. As another example, a wheel feature payout can be calculated as described with respect to block 567 shown in FIG. 27B. As still yet another example, a free spins quantity can be calculated as described with respect to block 568 shown in FIG. 27B. Other examples of calculations performed by the calculate module 478 are also possible.

### 9. Process Feature Module

The process feature module 479 can be configured to perform various features of the game. For example, the process feature module 479 can be configured to perform a base game feature, such as a power-up feature in the base game or a respin feature in the base game. Examples pertaining to a base game feature are described below in this section and with respect to block 560 shown in FIG. 27A. For example, the process feature module 479 can be configured to perform a wheel feature, such as a multiplier wheel feature, a wild rain wheel feature, a collect wheel feature, or a jackpot wheel feature. Examples pertaining to a wheel feature are described below in this section and with respect to block 565 shown in FIG. 27B. As yet another example, the process feature module 479 can be configured to perform a power-up feature with respect to a wheel feature. Examples pertaining to performing a power-up feature with respect to a wheel feature are described below in this section and with respect to block 566 shown in FIG. 27B.

As an example, the process feature module 479 can be configured to set a value within the counter 360, such as a value of a free spins counter. As another example, the process feature module 479 can be configured to increment or decrement a counter within the counters 360. For instance, the process feature module 479 can be configured to decrement a free spins counter upon initiating, during performance of, or after performance of a free spin of the game.

An another example, the process feature module 479 can be configured to determine the respin wild symbol 631 has landed and to responsively respin all empty cells within the grid 602. If the respin wild symbol 631 lands in the respun empty cells, the process feature module 479 can be configured respin any further empty cells within the grid 602. In accordance with at least some embodiments, the process feature module 479 will cause completion of at least one pay pattern during a round of the game in which the respin wild symbol landed.

An another example, the process feature module 479 can be configured to determine the diamond wild symbol 628 has landed and to responsively add a diamond into the accumulator 604. In other words, the process feature module 479 can be configured to trigger the display output module 474 to output an animation showing a diamond symbol being added into the accumulator 604. In some embodiments, a diamond is added into the accumulator 604 regardless of whether the diamond wild symbol is within a completed pay pattern. In other embodiments, a diamond is added into the accumulator 604 only if the diamond wild symbol is within a completed pay pattern. In some embodiments, the diamond wild symbol 628 has no direct value, similar to the normal wild symbol 630 and the L5 symbol 617.

An another example, the process feature module 479 can be configured to determine the power-up wild symbol 629 has landed and to responsively and randomly increase the value of one or more coin symbols output within the grid 602 during the round of the game.

As yet another example, the process feature module 479 can be configured to determine an outcome achieved by performing the game results in a wheel spin condition and subsequently determine a wheel spin outcome and cause the display output module 474 to output an animation that results in displaying the wheel spin outcome within the GUI 600. As an example, the wheel spin condition can comprise a predetermined amount of diamond symbols being collected in the accumulator 604. Other examples of the wheel spin condition are also possible. The process feature module 479 can be configured to request the display output module 474 to display an exploded view of the wheel and a user-selectable control selectable by the player to initiate spinning of the wheel 603. The process feature module 479 can be configured to request the draw module 475 to draw a number indicative of which wheel position of the wheel 603 is to land a the pointer 663. In accordance with at least some embodiments, process feature module 479 is configured to perform a power-up for a quantity of cells when the multiplier, collect, or wild rain feature occurs during a round of the game.

### 10. Game State Module

The game state module 480 can be configured to determine game stats for a current game state and for use in a next state of the game. As an example, game state module 480 can be configured to perform aspects described with respect to block 570 in FIG. 27B. For instance, the game state module 480 can be configured to decrement a free spin counter after initiating the free spin and determine whether the free spin counter indicates any further free spins are available to the player. If no further free spins are available to the player, the game state module 480 can be executed to enable the bet USC 612 shown in FIG. 7 so that the player can place a bet for the next round of the game. A processor can determine the next state of the game using the game state module 480 so that the processor knows which module to call to initiate the next state of the game.

### 11. Payout Module

The payout module 481 can be configured to perform aspects related to a game payout. As an example, the payout module 481 can be configured to determine whether a payout is to be awarded based on performance of a game. As another example, the payout module 481 can be configured to determine an amount of a game payout. As yet another example, the payout module 481 can be configured to provide the game payout. In accordance with at least some embodiments, determining whether a payout is to be awarded and/or an amount of a game playout can be based on modified data generated by the generate module 477.

In accordance with examples in which the game is played out, fully or at least partially, on a virtual game board, a game playout can be referred to as a “board payout.”

### III. Example Graphical User Interface

Next, FIGS. 7 to P15 show different views of a GUI 600. For example, FIG. 7 shows a view 601 of the GUI 600. As shown in FIG. 7 and other figures, the GUI 600 can include a grid 602, a wheel 603, an accumulator 604, jackpot indicators 605, player value indicators 606, and user-selectable controls 607. The GUI 600, or a portion of the GUI 600 (such as the grid 602), can be referred to as a virtual game board.

As an example, the grid 602 can comprise a rectangular grid as shown in FIG. 7. The grid 602 be arranged as other shapes, such as a triangle or some other shape. The grid 602 includes multiple cells. When the grid 602 is arranged as a rectangular grid, the grid 602 can be arranged with a quantity of columns and a quantity of rows. In one example, the grid 602 includes five columns and five row such that the grid 602 includes twenty-five cells. In accordance with that example, the columns, from left to right as shown in FIG. 7, can be referred to as column C1, C2, C3, C4, C5, and the rows, from top to bottom as shown in FIG. 7, can be referred to as row R1, R2, R3, R4 R5. Additionally or alternatively, the cells within the grid can be numbered with a sequence of consecutive integers, such as the consecutive integers in the range 0 to 24 or the range 1 to 25. Other examples of cell identifiers for cells within the grid 602 are also possible. The display output module 474 can determine symbols to display within each cell and use the cell identifiers and corresponding symbol identifiers when generating a GUI view. In accordance with at least some embodiments, cell 12 can be referred to as a “central cell,” a “central square,” a “free cell,” or by some other name or identifier. The grid 602 can be referred to as a “virtual grid.”

In accordance with at least some embodiments of the game, one or more particular cells within the grid 602 can always be marked as a completed cell. Such cell(s) can be referred to a “persistent completed cell(s).” In accordance with at least some of those embodiments, a persistent completed cell can form part of a winning pay pattern, even if the persistent completed cell does not add any value to an award associated with the winning pay pattern. As an example, the cell 12 can be a persistent completed cell. In FIG. 7 to FIG. 21, persistent completed cells are indicated by an L5 symbol 617 containing the characters “L5.”

The wheel 603 can comprise multiple wheel positions. The wheel 603 can referred to as a “virtual wheel.” In accordance with some embodiments, during some game states, a portion of the wheel 603 is displayed and another portion of the wheel 603 is not displayed as if the hidden portion of the wheel is behind the grid 602. Those game states can include game states in which the wheel 603 is not spinning (i.e., an animation showing the wheel 603 spinning is not being output by the display output module 474. In accordance with some embodiments, during some game states, an entirety of the wheel (i.e., all wheel positions) are visible within the GUI 600. Those game states can include game states in which the wheel 603 is spinning (i.e., an animation showing the wheel spinning is output by the display output module 474).

As an example, the wheel 603 can include eight wheel segments. In at least some embodiments, the wheel 603 includes a different number of wheel segments, such as two to twenty wheel segments or some other quantity of wheel segments greater than twenty wheel segments. Each wheel segment of the wheel 603 can include an action identifier. The action identifiers can be unique or two or more of the action identifiers can be duplicates of one another. As an example, the action identifiers can include first, second, third, fourth, fifth, sixth action identifiers. Table D shows example action identifiers that can be associated the six action identifiers. In accordance with at least some embodiments, the multi action identifier can be represented as a particular multiplier action identifier, such as a 2× multiplier action identifier or a 5× multiplier action identifier.

TABLE D

| Action Identifier | Example Action Identifier |
|---|---|
| First | Mega jackpot |
| Second | Major jackpot |
| Third | Multi |
| Fourth | Free spins |
| Fifth | Wild rain |
| Sixth | Collect |

The jackpot indicators 605 includes indicators corresponding to multiple jackpots, such as the Mega jackpot, the Major jackpot, the Minor jackpot, and the Mini jackpot, all of which as listed in Table I. The jackpot indicators 605 can show a value associated with each jackpot. The values associated with the jackpots can be modified as a result of game play at one or more computing systems.

The Multi action identifier can correspond to the multiplier wheel feature as described with respect to the process feature module 479 and block 566 shown in FIG. 27B. The Free spins action identifier can correspond to performing a quantity of free spins as described with respect to the process feature module 479 and block 566 shown in FIG. 27B. The Wild rain action identifier can correspond to the wild rain wheel feature as described with respect to the process feature module 479 and block 566 shown in FIG. 27B. The Collect action identifier can correspond to the collect wheel feature described with respect to the process feature module 479 and block 566 shown in FIG. 27B.

The accumulator 604 can include a segment of the GUI 600 at which symbols representing an accumulation of a particular symbol landing within the grid 602 over the course of playing rounds of the game. As an example, the particular symbol can be referred to as a “diamond wild” symbol. As diamond wild symbols land in the grid 602, execution of the display output module 474 can output an animation showing a diamond symbol being added into the accumulator 604. In FIG. 7, the accumulator 604 appears as a pot, but can be represented using other symbols.

In accordance with at least some embodiments, a visual appearance of the accumulator 604 is adjusted to show an increase after a predetermined quantity of diamond symbols have landed in the grid 602 and diamonds have been added to the accumulator 604. As an example, the accumulator 604 can be shown with multiple levels (e.g., three levels) of diamonds being shown without any visual changes to the accumulator. As another example, after a particular number of diamonds have been added to the accumulator 604, execution of the display output module 474 can output instability animations to represent cracks, shakes, and light escaping from the fractured accumulator 604. Outputting of the instability animations can represent that the accumulator is on the verge of exploding, thus heightening player anticipation for a further diamond needed to trigger a wheel feature corresponding to the wheel 603. At a random time, after the accumulator 604 has suitably grown, the wheel feature can be awarded to the player.

The player value indicators 606 is a portion of the GUI 600 at which one or more value indicators corresponding to a player are displayed. As an example, the player value indicators 606 can include a balance indicator 608 to indicate a value of a player account. This value can indicate a value that equals deposits to the player account plus winnings by the player minus bets placed by the player minus withdrawals from the player account. As another example, the player value indicators 606 can include a bet indicator 609 to indicate an amount of a bet placed on a round of the game. As yet another example, the player value indicators 606 can include a win indicator 610 to indicate an amount won as a result of playing a round of the game.

The user-selectable controls 607 is one or more portions of the GUI 600 at which user-selectable controls are located. As an example, the user-selectable controls 607 can include a spin USC 611 selectable to trigger the user interface module 471 to determine the selection and call for execution of another module to perform a round of the game in response to the selection of the spin USC 607.

As another example, the user-selectable controls 607 can include a bet USC 612 selectable to change a bet for one or more upcoming rounds of the game.

As yet another example, the user-selectable controls 607 can include an auto-play USC 613 to initiate performance of multiple rounds of the game without having to select a USC, such as the spin USC 611 before performance of each round of the multiple rounds.

As a further example, the user-selectable controls 607 can include a buy feature USC 614 selectable to present options for selecting specific features of the game without having to be awarded the features, such as a bonus process feature performable by the process feature module 479. For instance, the buy feature USC 614 selectable to present options for the player to pay a fee to have the process feature module 479 perform the wheel feature, the collect feature, the wild rain feature, the multiplier feature, or the free spin feature. In accordance,

As yet a further example, the user-selectable controls 607 can include a menu USC 615 selectable to display a menu, such as a menu for selecting game set-up features.

As yet a further example, the user-selectable controls 607 can include a game speed USC 616 selectable to increase or decrease a speed of the game being played out. If the game has two play-out speeds (e.g., slow and fast), selecting the game speed USC 616 can toggle the game speed between slow and fast. If the game more than two play-out speeds (e.g., slow, medium, and fast), selecting the game speed USC 616 can change the game speed based on an ordered sequence of the play-out speeds).

Multiple pay patterns can be defined with respect to the grid 602. As an example, twelve pay patterns including five horizontal pay patterns, five vertical pay patterns, and two diagonal pay patterns can be defined with respect to the grid 602. A configuration file stored in the data structure 359 can include configuration data defining pay patterns for game. Table E shows an example of configuration data defining pay patterns for game. In at least some embodiments, the configuration file includes data defining pay patterns with identifiers 0 to 11. In at least some embodiments, the configuration file includes data defining pay patterns with any or all of identifiers 0 to 14. Table E shows that pay patterns defined for a game can include different quantities of cells.

TABLE E

| Pay pattern identifier | Pay pattern type | Pattern cells |
|---|---|---|
| 0 | Horizontal | 0, 1, 2, 3, 4 |
| 1 | Horizontal | 5, 6, 7, 8, 9 |
| 2 | Horizontal | 10, 11, 12, 13, 14 |
| 3 | Horizontal | 15, 16, 17, 18, 19 |
| 4 | Horizontal | 20, 21, 22, 23, 24 |
| 5 | Vertical | 0, 5, 10, 15, 20 |
| 6 | Vertical | 1, 6, 11, 16, 21 |
| 7 | Vertical | 2, 7, 12, 17, 22 |
| 8 | Vertical | 3, 8, 13, 18, 23 |
| 9 | Vertical | 4, 9, 14, 19, 24 |
| 10 | Diagonal | 0, 6, 12, 18, 24 |
| 11 | Diagonal | 4, 8, 13, 16, 20 |
| 12 | Four corners | 0, 4, 12, 20, 24 |
| 13 | Small X | 6, 8, 12, 16, 18 |
| 14 | Large X | 0, 4, 6, 8, 12, 16, 18, 20, 24 |

Next, FIG. 8 shows a view 635 of the GUI 600. The view 635 shows examples of additional symbols that can be displayed within the grid 602. As an example, the grid 602 can display a numerical coin symbol 618, 619, 620, 621, 622, 623, 624, a minor symbol 625, a mini symbol 626, and a mystery box symbol 627, a diamond wild symbol 628, a power-up wild symbol 629, a normal wild symbol 630, and a respin wild symbol 631.

In accordance with at least some embodiments, particular symbols are limited to being displayed in one or more particular symbols. For instance, the L5 symbol 617, power-up wild symbol 629, and the respin wild symbol 631 are limited to being displayed in cell 12.

Next, FIG. 9 shows a view 636 of the GUI 600. In view 636, three completed pay patterns are shown in the grid 602. In particular, the completed pay patterns include a pay pattern 632 comprising a horizontal pay pattern includes cells 5 to 9 (identified in FIG. 7), a pay pattern 633 comprising a vertical pay pattern including cells 1, 6, 11, 16, 21 (identified in FIG. 7), and a pay pattern 634 comprising a diagonal pay pattern including cells 0, 6, 12, 18, and 24 (identified in FIG. 7). Based on this example, the player wins the total of each completed pay pattern. The total of the pay pattern 632 is 10.30 (i.e., 2+5+0.8+1+1.5). The total of the pay pattern 633 is 10.50 (i.e., 5+5+0.5). The total of the pay pattern 634 is 7.60 (i.e., 0.1+5+1+1.5) and does not include any value based on the L5 symbol 617. A total payout for the pay pattern 632, the pay pattern 633 and the pay pattern 634 based on the view 636 is 28.40. The total payout can be based on a local currency, such as dollars, pesos, pounds, or Euros. In view 636, the accumulator 604 shows that quantity of diamond greater than zero have been selected.

FIG. 9 shows a different position for the bet USC 612 and a different position for the menu USC 615 relative to positions of the bet USC 612 and the menu USC 615 shown in FIG. 7. FIG. 9 does not show the auto-play USC 613, the buy feature USC 614, or the game speed USC 616. Some USC may be removed from the USC 600 during some operating states if that USC is not selectable during those operating states. Some USC may be removed from the USC 600, but can appear again via selection of the menu USC 615, for example.

Next, FIG. 10 shows a view 637 of the GUI 600. In view 637, a result for around of the game that has led to no win for the player is shown. In other words, in view 637, no pay pattern is completed. In view 637, no diamonds are visible within the accumulator. This could indicate that no diamond wild symbols have landed since the player began playing, the accumulator 604 has been emptied after a prize based on a previous accumulation of diamond wild symbols has been awarded, or an insufficient number of diamond wild symbols have been accumulated in the accumulator 604 to represent a first level of diamonds within the accumulator 604.

The view 637 (among other views) of the GUI 600 include a jackpot indicator 649, 650, 651, 652 corresponding to a mega jackpot, a major jackpot, a minor jackpot, and a mini jackpot, respectively. In accordance with at least some embodiments, the player is awarded an amount indicated by the jackpot indicator 651 if the minor symbol 625 lands within a completed pay pattern, and the player is awarded an amount indicated by the jackpot indicator 652 if the mini symbol 626 lands within a completed pay pattern. Since the minor symbol 625 shown in the view 637, the minor jackpot is not awarded based on a round of the game resulting in the view 637.

Next, FIG. 11 shows a view 638 of the GUI 600. In view 638, the mystery box symbol 627 has landed within the pay pattern 632. The process feature module 479 can be executed when the mystery box symbol 627 has landed within a completed pay pattern. As an example, the process feature module 479 can, for example, randomly determine a symbol representative of or corresponding to a monetary amount. As another example, the process feature module 479 can display the mystery box symbol 627 in lieu of another symbol representing or corresponding to a largest monetary amount within the pay pattern comprising the mystery box symbol 627. Revealing a symbol hidden by the mystery box symbol 627 can result in increased player anticipation and/or enjoyment while playing the game. In accordance with at least some embodiments, the mystery box symbol 627 will be opened if a collect feature or a wild rain feature is performed even if the mystery box symbol 627 is not on a completed pay pattern.

Next, FIG. 12 shows a view 639 of the GUI 600. The view 639 represents an animation showing the mystery box symbol 627 within the view 638 changing to the hidden symbol to reveal the symbol representative of or corresponding to a monetary amount. As an example, the hidden symbol can be a coin symbol, such as a coin symbol equal to two or five times the bet amount indicated by the bet indicator 609, the minor symbol 625, or the mini symbol 626.

Next, FIG. 13 shows a view 640 of the GUI 600. In view 640, the respin wild symbol 631 landed at cell 8. In view 640, no pay pattern is complete and cells 1, 3, 5, 7, 9, 10, 11, 14, 17, 18, 20, 21, and 23 are empty (i.e., are empty cells).

Next, FIG. 14 shows a view 641 of the GUI 600. View 641 represents that an animation is performed in response to the respin wild symbol 631 landing within the grid 602. As an example, the animation can include displaying the respin wild symbol 631 overlaid upon an entirety of the grid 602. As another example, the animation can show cells 1, 3, 5, 7, 9, 10, 11, 14, 17, 18, 20, 21, and 23 respinning and a result of the empty cells respinning. As an example, all empty cells can start spinning at a first time and stop spinning at a second time. As another example, the empty cells can start spinning sequentially and stop spinning sequentially. The sequence, for example, can be from the lowest numbered empty cell to the greater numbered empty cell. As yet another example, the empty cells can start spinning in a first random order and stop spinning in the first random order or a second random order.

Next, FIG. 15 shows a view 642 of the GUI 600. View 642 shows a screen shot of the GUI 600 while some of the empty cells are spinning. In particular, the cells 1, 3, 5, 7, 9, 10, 11, 14 are spinning. The cells 17, 18, 20, 21, and 23 have not started respinning or have already respun and remained empty.

Next, FIG. 16 shows a view 643 of the GUI 600. In view 643, the power-up wild symbol 629 has landed in cell 6 and within the pay pattern 632 along with the numerical coin symbol 623 at cell 5, the numerical coin symbol 622 at cell 7, the numerical coin symbol 618 at cell 8, and the numerical coin symbol 621 at cell 9. Execution of the process feature module 479 causes a processor to determine the power-up wild symbol 629 has landed and responsively and randomly increase the value of one or more coin symbols output within the grid 602. In at least some embodiments, the process feature module 479 is configured to increase the value of one or more coin symbols only if the power-up wild symbol 629 lands within a completed pay pattern.

Next, FIG. 17 shows a view 644 of the GUI 600. View 644 represents that an animation is performed in response to the power-up wild symbol 629 landing within the grid 602. As an example, the animation can include displaying the power-up wild symbol 629 overlaid upon an entirety of the grid 602.

Next, FIG. 18 shows a view 645 of the GUI 600. View 645 shows a result of the process feature module 479 causing the processor to randomly increase the value of one or more coin symbols output within the grid 602 in response to determining the power-up wild symbol 629 has landed within the grid 602 or within a completed pay pattern. Compared to the view 643, the numerical coin symbol 619 is displayed in cell 5 instead of the numerical coin symbol 623, and the numerical coin symbol 624 is displayed in cell 8 instead of the numerical coin symbol 618. The coin symbols within cells 7 and 9 did not change (i.e., did not power up). Additionally, the power-up wild symbol at cell 5 has been replaced with the normal wild symbol 630. As a result of performing the power-up feature, an award based on the pay pattern 632 increased from 3.40 to 9.30.

Next, FIG. 19 shows a view 646 of the GUI 600. View 646 shows the GUI 600 after the process feature module 479 has executed to add diamond(s) into the accumulator 604 and to change the diamond wild symbol 628 at cell 3 to the normal wild symbol 630. Those changes can be noticed by comparing the view 635 in FIG. 8 to the view 646.

Returning to FIG. 7, the wheel 603 includes multiple wheel positions in which different wheel symbols can be displayed. In some embodiments, none of the wheel symbols on the wheel 603 are duplicates, whereas in other embodiments, two or more wheel symbols are duplicate wheel symbols. FIG. 7 shows the following wheel symbols: a major wheel symbol 653, a multi wheel symbol 654, a wild rain wheel symbol 655, and a free spin wheel symbol 656. FIG. 9 shows a multiplier wheel symbol. In particular, FIG. 9 shows a 5× multiplier wheel symbol 657. FIG. 11 shows a collect wheel symbol 658 and a 2× multiplier wheel symbol 659. FIG. 12 shows a mega wheel symbol 660.

Next, FIG. 20 shows a view 647 of the GUI 600. In view 647, an exploded view of the wheel 603 is shown within the GUI 600. In view 647, a user-selectable control 661 selectable by the player to initiate spinning of the wheel 603. The GUI 600 can include an instruction 662 to guide a user in continuing playout of the round of the game. The GUI 600 can include a pointer 663 to indicate which wheel symbol on the wheel 603 represents a result of spinning the wheel 603.

Next, FIG. 21 shows a view 648 of the GUI 600. In view 648, the wheel position 664 is shown after having stopped at the pointer 663 and then expanded in size. The process feature module 479 can execute to perform a feature corresponding to the feature indicated by the wheel position 664. If the wheel position 664 shows the major wheel symbol 653, a jackpot indicated by the jackpot indicator 650 can be awarded to the player. If the wheel position 664 shows the mega wheel symbol 660, a jackpot indicated by the jackpot indicator 649 can be awarded to the player.

If the wheel position 664 shows the multi wheel symbol 654, the process feature module 479 can execute to increase a value of random coins in any or all completed pay patterns within the grid 602, and then the request the display output module 474 to display another wheel (e.g., horizontal wheel) with multiple multiplier values (e.g., 2×, 3×, 5× and 10×) thereon and to request the draw module 476 to draw a random number to select a multiplier value for showing within the other wheel as the selected multiplier value. The process feature module 479 can request the calculate module 478 to determine an award based on the coin symbols within the completed pay patterns times the selected multiplier value. The process feature module 479 can request the payout module 481 to output the determined award.

If the wheel position 664 shows the free spin wheel symbol 656, the process feature module 479 can execute to perform a quantity of free spins (e.g., ten free spins) of the game. After each free spin, the process feature module 479 can perform the power-up feature to randomly increase the value of one or more coin symbols output within the grid 602 after the free spin. In accordance with at least some embodiments, the process feature module 479 replaces the diamond wild symbol 628 with a +1 wild symbol if the diamond wild symbol 628 is selected to be displayed within the grid 602. If the +1 wild symbol lands within the grid 602, one extra free spin is awarded for each instance of the +1 wild symbol landing within the grid 602.

If the wheel position 664 shows the wild rain wheel symbol 655, the process feature module 479 can execute to perform the power-up feature (e.g., randomly increase the value of one or more coin symbols output within the grid 602 during the round of the game) and then request the display output module 474 to replace all empty cells within the grid with a normal wild symbol such that all pay patterns are completed. The process feature module 479 can request the calculate module 478 to determine an award based on the completed pay patterns. The process feature module 479 can request the payout module 481 to output the determined award.

If the wheel position 664 shows the collect wheel symbol 658, the process feature module 479 can execute to perform the power-up feature (e.g., randomly increase the value of one or more coin symbols output within the grid 602 during the round of the game) and then request the calculate module 478 to determine an award based on coin symbols within the grid 602 regardless of whether the coin symbols are located within a completed pay pattern. The process feature module 479 can request the payout module 481 to output the determined award.

The coin symbols shown in FIGS. 8 to P13 can be selected from a set of coin symbols corresponding to a bet indicated by the bet indicator 609. As the value of the bet increases, the values of coins represented by the set of coin symbols corresponding to the bet increase as compared to sets of coin symbols corresponding to small bet values.

Weighting can be applied to particular symbols to enable them to land according to desired gameplay characteristics and player experience. Since there is no reel strip to configure, weighting can ensure that the return-to-player (RTP) of the game remain as specified. Moreover, weighting can be applied to the wheel features to ensure that appropriate prizes are awarded in line with the RTP requirements.

In at least some embodiments, after symbols for the grid 602 have been determined and displayed, a USC 667 can be output within the GUI 600. The USC 667 and/or the GUI 600 can indicate a fee associated with performing a supplemental spin if the USC 667 is selected. The USC 667 is selectable to cause the process feature module 479 to request the draw module 476 to select random numbers for determining whether empty cells within the grid 602 are to remain empty or a new symbol to display within the empty cell. The process feature module 479 can then request the display output module 474 to output animations showing the empty cells spinning and the displaying the cell as empty again or with the new symbol. This feature provides the player with a chance to increase an award earned on the initial symbol set displayed within the grid 602 for the round of the game. The calculate module 478 can calculate a cost of the supplemental spin based on a relative advantage to be gained by the player due to symbol positions that have already been populated, as well as values of coin symbols that potentially could be displayed within the grid 602 if the supplemental spin occurs. The symbols initially displayed within the grid for the round of the game remain in place, while the empty cells are recalculated.

In at least some embodiments, the GUI 600 includes a USC 668 selectable to ensure that the diamond wild symbol 628 appears within the grid 602 at least once during the round of the game. The USC 668 and/or the GUI 600 can indicate a fee associated with providing the guarantee of the diamond wild symbol 628 landing if the USC 668 is selected. This feature can be referred to a booster bet feature performed by the process feature module 479. Triggering the wheel 603 can remain random once a predetermined quantity of diamonds have accumulated in the accumulator 604 even if the booster bet features is selected and paid for.

In at least some embodiments, each symbol can have a particular impact on a round of the game, but for most symbols to be considered as part of a winning result and thus result in an award for the player, the symbol must appear within a completed pay pattern. In at least some embodiments, such as an embodiment in which the grid 602 includes twenty-five cells, the pay pattern must have five symbols to form a completed pay pattern. This differs from video slot games where fewer than an a full available number of symbols on a payline can lead to a win (e.g., three or four symbols out of a possible five symbols).

### IV. Example Method

Next, FIG. 22A and FIG. 22B show a flow chart showing a set 500 of functions that can be carried out using a computing system (e.g., the computing system 100 of FIG. 2, the computing system 100a and/or the computing system 100b shown in FIG. 3, or some other computing system). The functions of the set 500 are shows in blocks 501 to 508. A method of the example embodiments can include performing one or more functions of the set 500 and/or a portion of one or more functions of the set 500. Additionally, the order in which the functions of set 500 are illustrated in FIG. 22A and FIG. 22B and described below is not intended to be limiting.

Accordingly, a method based on one or more functions of the set 500 can include a computer-implemented method that includes the computing system executing one or more of the modules 335.

Block 501 includes outputting, on a display, a virtual game board, the virtual game board including a grid with multiple cells indexed to respective cell positions within the grid. Each cell being adapted to display a symbol corresponding to a state of the cell determined for a round of the game. The function(s) of block 501 can be performed by a processor (e.g., one or more hardware processors) configured by machine-readable instructions including a module that is the same as or similar to the display output module 474 (shown in FIG. 6), in accordance with the example embodiments. The functions of block 501 can include one or more of the functions described with respect to the display output module 474. As an example, the processor can configure a computing system to operate using a first jackpot state for a game with multiple jackpot states, as discussed in in connection with the display output module 474.

Next, block 502 includes initiating, within a computer-readable memory, a data structure to contain initial game data for the round of the game to be displayed on the virtual game board. The function(s) of block 502 can be performed by a processor (e.g., one or more hardware processors) configured by machine-readable instructions including a module that is the same as or similar to the initiate module 477 (shown in FIG. 6), in accordance with the example embodiments. The functions of block 502 can include one or more of the functions described with respect to the initiate module 477. As an example, the processor can configure a computing system to initiate, within a computer-readable memory, a data structure to contain initial game data for a round of a game to be displayed on the virtual game board, as discussed in in connection with the initiate module 477.

Next, block 503 includes performing multiple drawings using a random number generator to determine a tokens quantity, a first token-type quantity, a second token-type quantity, and cell positions within the grid for placement of a quantity of symbols equal to the tokens quantity. The function(s) of block 503 can be performed by a processor (e.g., one or more hardware processors) configured by machine-readable instructions including a module that is the same as or similar to the draw module 476 (shown in FIG. 6), in accordance with the example embodiments. The functions of block 503 can include one or more of the functions described with respect to the draw module 476. As an example, the processor can perform multiple drawings using a random number generator to determine a tokens quantity, a first token-type quantity, a second token-type quantity, and cell positions within the grid for placement of a quantity of symbols equal to the tokens quantity, as discussed in in connection with the draw module 476.

Next, block 504 includes performing the first token-type quantity of drawings and the second token-type quantity of drawings to determine new states of at least some of the multiple cells. The function(s) of block 504 can be performed by a processor (e.g., one or more hardware processors) configured by machine-readable instructions including a module that is the same as or similar to the draw module 476 (shown in FIG. 6), in accordance with the example embodiments. The functions of block 504 can include one or more of the functions described with respect to the draw module 476. As an example, the processor can perform the first token-type quantity of drawings and the second token-type quantity of drawings to determine new states of at least some of the multiple cells, as discussed in in connection with the draw module 476.

Next, block 505 includes generating, within the data structure, modified data corresponding to the round of the game based on the multiple drawings and the new states of at least some of the multiple cells. The modified data indicating a set of symbols and corresponding cell positions where to display the set of symbols during performance of the round of the game. The function(s) of block 505 can be performed by a processor (e.g., one or more hardware processors) configured by machine-readable instructions including a module that is the same as or similar to the generate module 477 (shown in FIG. 6), in accordance with the example embodiments. The functions of block 505 can include one or more of the functions described with respect to the generate module 477. As an example, the processor can generate, within the data structure, modified data corresponding to the round of the game based on the multiple drawings and the new states of at least some of the multiple cells, as discussed in in connection with the generate module 477.

Next, block 506 includes determining a board payout based on the modified data. The function(s) of block 506 can be performed by a processor (e.g., one or more hardware processors) configured by machine-readable instructions including a module that is the same as or similar to the payout module 481 (shown in FIG. 6), in accordance with the example embodiments. The functions of block 506 can include one or more of the functions described with respect to the payout module 481. As an example, the processor can determine a board payout based on the modified data, as discussed in in connection with the payout module 481.

Next, block 507 includes outputting, within the virtual game board on the display, an animation representing a respective reel spinning in at least some of the multiple cells until the respective reel stops to display a symbol corresponding to a state of the cell determined for the round of the game. The function(s) of block 507 can be performed by a processor (e.g., one or more hardware processors) configured by machine-readable instructions including a module that is the same as or similar to the display output module 474 (shown in FIG. 6), in accordance with the example embodiments. The functions of block 507 can include one or more of the functions described with respect to the display output module 474. As an example, the processor can output, within the virtual game board on the display, an animation representing a respective reel spinning in at least some of the multiple cells until the respective reel stops to display a symbol corresponding to a state of the cell determined for the round of the game, as discussed in in connection with the display output module 474.

Next, block 508 includes providing the board payout. The function(s) of block 508 can be performed by a processor (e.g., one or more hardware processors) configured by machine-readable instructions including a module that is the same as or similar to the payout module 481 (shown in FIG. 6), in accordance with the example embodiments. The functions of block 508 can include one or more of the functions described with respect to the payout module 481. As an example, the processor can provide the board payout, as discussed in in connection with the payout module 481.

### V. Example Method Functions

Next, FIG. 27A and FIG. 27B show a flow chart showing a set 550 of functions that can be carried out using a computing system (e.g., the computing system 100 of FIG. 2, the computing system 100a and/or the computing system 100b shown in FIG. 3, or some other computing system). The functions of the set 550 are shows in blocks 551 to 570. A method of the example embodiments (e.g., a method based on one or more functions shown in the set 500 of functions shown in FIG. 22A and FIG. 22B) can include performing one or more functions of the set 550 and/or a portion of one or more functions of the set 550. Additionally, the order in which the functions of set 550 are illustrated in FIG. 27A and FIG. 27B and described below is not intended to be limiting.

Accordingly, a method based on one or more functions of the set 550 can include a computer-implemented method that includes the computing system executing one or more of the modules 335.

Block 551 includes drawing a tokens quantity. The draw module 476 can be configured to draw the tokens quantity. As an example, the draw module 476 can be configured to draw an integer from a set of integers ranging from 0 to 24. For a grid with 25 cells and one free cell (e.g., cell 12), then the upper value in the range is 24 because the free cell in a non-empty cell. The tokens quantity indicates the number of cells that will have a value other than the value indicative of an empty cell (e.g., a value of −1).

In accordance with at least some embodiments, the draw module 476 is configured so that the tokens quantity is between 11 and 24 so that the grid is not “too empty.” The draw module 476 can include weighting so that the tokens quantity is greater than or equal to 11. Table C shows example criteria for selecting a tokens quantity between 11 and 24. In accordance with at least some other embodiments, the weighted range to avoid the grid from being “too empty” can be extended to a range of 10 to 24, 9 to 24, 8 to 24, or some other range.

A person having ordinary skill in the art will understand that the tokens quantity could be determined by drawing a quantity of empty cells and determining the tokens quantity by subtracting the quantity of empty cells plus the free cell from the total quantity of cells. A software identifier corresponding to the tokens quantity can be TokensQty or some other identifier.

Next, block 552 includes drawing a tokens-type quantity. The draw module 476 can be configured to draw the tokens-type quantity. As an example, the tokens-type quantity can be a quantity of a particular type of symbol to be displayed within the grid 602, such as a quantity of diamond wild symbols. The configuration file within the data structure 359 can define a range for drawing the tokens-type quantity. For example, the range can be 0 to 5 diamond wild symbols. Other examples of the range are also possible. Table F shows example criteria that can be used when selecting a tokens-type quantity. The possible values available to be drawn are based on the tokens quantity determined at block 552, a quantity of free spins triggers and quantity of wheel triggers. The probability of selecting a particular value is based on the hits corresponding to the values in each particular criteria.

TABLE F

| | FreeSpins | Wheel | | |
|---|---|---|---|---|
| TokensQty | TriggerQty | TriggerQty | Values | Hits |
| 11 | 0 to 3 | 0, 1 | 0, 1, 2, 3, | 5,000, 4,500, |
| | | | 4, 5 | 470, 25, 4, 1 |
| 12 to 15 | 0 to 3 | 0, 1 | 0, 1, 2, 3, | 5,500, 2,800, |
| | | | 4, 5 | 1,663, 32, 4, 1 |
| 16 to 24 | 0 to 3 | 0, 1 | 0, 1, 2, 3, | 95,000, 150, |
| | | | 4, 5 | 4,750, 95, 4, 1 |
| 11 to 24 | 4 | 0 | 0, 1 | 5, 5 |
| 11 to 24 | 4 | 1 | 0 | 1 |

Next, block 553 includes drawing token positions (e.g., grid cells or cell positions). The token positions can indicate which cells will include a wild symbol and which cells will include a coin symbol. As an example, execution of the draw module 476 can result in drawing the token positions. As an example, drawing token positions can include determining which cells will include diamond symbols and which cells will have coin symbols such that the data structure can be modified to include data indicating whether each cell has an empty state, a wild symbol state, or a coin symbol state. The token positions can be randomly drawn from the twenty-four cells other than cell 12 (i.e., the symbol including the L5 symbol). The coin symbol state can be referred to as the “coin” state.

Next, block 554 includes calculating board stats (i.e., board statistics, grid stats, or grid statistics). The calculate module 478 can be configured to calculate the board stats. The board statistics can be used when performing certain drawings via execution of the draw module 476.

As an example, calculating the board stats can include referring to the data structure indicating the state of each cell and determining a quantity of completed patterns (e.g., a quantity of pay patterns that are or will be completed based the state of each cell). A software identifier corresponding to this quantity stat can be PaylinesQty or some other identifier. This board state can be an integer greater than or equal to zero.

As another example, calculating the board stats can include referring to the data structure indicating the state of each cell (e.g., whether cell has a “coin state”, a “wild state” (represented as “0”) or an “empty state” (represented as “−1”) and determining a quantity of coin symbols that will result in a pay-out. Table G shows an example of some board stats (e.g., Boolean values (i.e., true or false) indicating whether a cell is a paying cell). In this example, the cells corresponding to cell identifiers 0, 5 to 10, 15, and 20 are paying cells because each of those cells has the coin state and in combination complete two paylines within the grid. The coin symbols in the determined quantity of coin symbols are coin symbols within a completed pay pattern (i.e., 9 coin symbols based on the data in Table G). Diamond wild symbols are not counted to determine this quantity. A software identifier corresponding to this quantity stat can be PayCellsQty or some other identifier. This board state can be an integer greater than or equal to zero.

TABLE G

| Cell identifier | Cell state | IsPayCell? value |
|---|---|---|
| 0 | Coin | True |
| 1 | −1 | False |
| 2 | Coin | False |
| 3 | −1 | False |
| 4 | Coin | False |
| 5 | Coin | True |
| 6 | Coin | True |
| 7 | Coin | True |
| 8 | Coin | True |
| 9 | Coin | True |
| 10 | Coin | True |
| 11 | −1 | False |
| 12 | 0 | False |
| 13 | Coin | False |
| 14 | −1 | False |
| 15 | Coin | True |
| 16 | Coin | False |
| 17 | −1 | False |
| 18 | −1 | False |
| 19 | Coin | False |
| 20 | Coin | True |
| 21 | −1 | False |
| 22 | −1 | False |
| 23 | Coin | False |
| 24 | −1 | False |

The data in Table G represents an example in which some cells have the IsPayCell? value true and some cells have the IsPayCell? value false. A person having ordinary skill in the art will understand that in some instances of performing a round of the game, all cells within the grid can have the IsPayCell? value of true, and in another round of the game, all cells within the grid can have the IsPayCell? value of false. The data in Table G represents an example in which the quantity of pay cells equals 10, the quantity of non-paying cells equals 16, and the quantity of paylines equals 2. Other examples where those quantities have different values are possible.

As yet another example, calculating the board stats can include determining a quantity of cells with coin symbols that will be paying with repetition. Such cells are cells with coin symbols in multiple completed pay patterns. Wild symbols are not counted to determine this quantity. A software identifier corresponding to this quantity stat can be PayTokensQty or some other identifier. This board state can be an integer greater than or equal to zero.

As still yet another example, calculating the board stats can include determining, for each cell, whether the cell is within a completed pay pattern or not. A software identifier corresponding to this stat can be PayCell or some other identifier. This board stat can be a Boolean value, such as true or false.

Next, block 555 includes drawing token values distribution. The draw module 476 can be configured to draw the token values distribution. The token value distributions can be contained in the configuration file of the data structure. Each token value distribution can correspond to a respective integer selectable using an RNG. As an example, the draw module 476 can be configured to draw a first token values distribution for paying cells (e.g., cells that have the state “coin”) and a second token values distribution for non-paying cells (e.g., cells that have the empty state or a non-paying wild symbol). In some embodiments, the first and second token values distributions are selected without reference to the states of the grid cells. In other embodiments, the first tokens value distribution is selected if at least one cell in the grid has the “coin state” and the second tokens values distribution is selected if at least one cells in the grid has the “empty state.”

The distributions can be a software object used to obtain coin values for the cells with the coin symbol state. Each of those objects can be referred to as a “distributions object.” Each selectable distribution can have a unique name, such as “D1”, “D2”, “D3” or “D4.” The distributions can be drawn, at least in part, based on the grid stats determined at block 554. The configuration file stored in the data structure can include separate objects for drawing distributions for non-paying cells and paying cells. An example object including criteria for drawing a distribution for non-paying cells is shown in Table H and an example object including criteria for drawing a distribution for paying cells is shown in Table I. The distribution probabilities correspond to the token values distributions in those tables in the orders shown. The RNG used when drawing the token values distributions can be configured according to the distribution probabilities.

TABLE H

| Criteria type | Criteria | Drawing values |
|---|---|---|
| Pay cell state | False | Null |
| Tokens quantity | 11 to 24 | Null |
| Pay tokens quantity | 0 to 56 | Null |
| Pay lines quantity | 0 to 12 | Null |
| Free spin state | True, False | Null |
| Diamonds quantity | 0 to 5 | Null |
| Token values distribution | Null | D1, D2 |
| Distribution probabilities | Null | 0.5, 0.5 |

TABLE I

| Criteria type | Criteria | Drawing values |
|---|---|---|
| Pay cell state | True | Null |
| Tokens quantity | 11 to 24 | Null |
| Pay tokens quantity | 0 to 56 | Null |
| Pay lines quantity | 0 to 12 | Null |
| Free spin state | True, False | Null |
| Diamonds quantity | 0 to 5 | Null |
| Token values distribution | Null | D3, D4 |
| Distribution probabilities | Null | 0.5, 0.5 |

The token values distributions at block 555 can be defined within the configuration file stored at the data structure 359. As example, each distribution can indicate coin values, a quantity of each kind of fixed coins to be populated in the grid, a quantity of wilds with zero value, probabilities for drawing each quantity of wilds, coin values, and a respective quantity of each coin value that form a pool of coin values that will be used to fill cells in a draw without replacement. As an example, those aspects can be identified using the following labels FixedCoins, FixedCoinsQty, WildsQty, WildsProbabilities, Coin Values, and Hits, respectively. Table J and Table M show example values that can be associated with those labeled aspects for a first distribution and a second distribution.

TABLE J
Distribution Name: DN1

| Label | Values |
|---|---|
| FixedCoinsValue | 1, 2 |
| FixedCoinsQty | 3, 1 |
| WildsQty | 0, 1, 2 |
| WildsProbabilities | 5, 15, 80 |
| CoinValues | 0.1, 0.2, 0.5, 0.8, 1, 1.5, 2, 5, 10, 25 |
| Hits | 200, 200, 200, 200, 100, 50, 40, 6, 3, 1 |

TABLE K
Distribution Name: DN2

| Label | Values |
|---|---|
| FixedCoinsValue | 1, 2 |
| FixedCoinsQty | 3, 1 |
| WildsQty | 0, 1, 2 |
| WildsProbabilities | 5, 15, 80 |
| CoinValues | 0, 0.1, 0.2, 0.5, 0.8, 1, 1.5, 2, 5, 10, 25 |
| Hits | 100, 100, 200, 200, 200, 100, 50, 40, 6, 3, 1 |

TABLE L
Distribution Name: DN3

| Label | Values |
|---|---|
| FixedCoinsValue | 1, 2 |
| FixedCoinsQty | 3, 1 |
| WildsQty | 0, 1, 2 |
| WildsProbabilities | 5, 15, 80 |
| CoinValues | 0.1, 0.2, 0.5, 0.8, 1, 1.5, 2, 5, 10, 25 |
| Hits | 300, 300, 300, 300, 150, 20, 5, 3, 2, 1 |

TABLE M
Distribution Name: DN4

| Label | Values |
|---|---|
| FixedCoinsValue | 1, 2 |
| FixedCoinsQty | 3, 1 |
| WildsQty | 0, 1, 2 |
| WildsProbabilities | 5, 15, 80 |
| CoinValues | 0, 0.1, 0.2, 0.5, 0.8, 1, 1.5, 2, 5, 10, 25 |
| Hits | 200, 200, 400, 400, 200, 25, 20, 5, 3, 2, 1 |

As shown in Table J, Table K, Table L, and Table M, the values of fixed coins is 1 and 2 and the fixed coins quantities indicates there are three coins of value 1 and one coin of value 2. In accordance with some embodiments, fixed coins are not used. A person skilled in the art will understand that other distributions can be contained within the configuration file that include the labels and values in Table J, Table K, Table L, and Table M except for the FixedCoin and FixedCoinsQty labels and corresponding values.

As an example, the symbol identifiers 1002 to 100B in Table A can correspond to the Coin Values in Table K to Table M.

Next, block 556 includes drawing token values (i.e., coin values). The draw module 476 can be configured to draw the token values. In other words, the draw module 476 can be configured to draw values to associate with cells having the coin symbol state. The draw module 476 can be configured to draw the token values from the token values distribution drawn at block 555 (e.g., the first token values distribution for paying cells and the second token values distribution for non-paying cells). The draw module 476 can be configured to read the grid stats (determined at block 554) to determine the quantity of paying cells and the quantity of non-paying cells and reserve, in the data structure 359, a first list with length equal to the quantity of paying cells and a second list with length equal to the quantity of non-paying cells. The first and second lists can be empty prior to populating the lists. Based on the example data shown in Table G, first list can have a length for 9 pay cells and the second list can have a length for 16 non-paying cells.

If the first token values distribution for paying cells includes any fixed coins, then the draw module populates the first empty list with coin values of the fixed coins and the quantity of each type (value) of fixed coin. Afterwards, if the first list is not full, the draw module 476 can draw a quantity of wilds to include the in the first list. Based on the distribution DN3 and DN4 above, the probability of the draw module 476 drawing zero wilds is 5%, drawing one wild is 15% and drawing two wilds is 85%. Afterwards, if the first list is not full, the draw module 476 can draw a quantity of coins needed to fill the first list. Based on the distribution DN3, the draw module 476 can draw coins without replacement from a set of coins including 300 coins of value 0.1, 300 coins of value 0.2, 300 coins of value 0.5, 300 coins of value 0.8, 150 coins of value 1, 20 coins of value 1.5, 5 coins of value 2, 3 coins of value 5, 2 coins of value 10, and 1 coin of value 25. Alternatively, if the distribution DN4 was selected, the draw module 476 can draw coins without replacement from a set of coins including 200 coins of value 0, 200 coins of value 0.1, 400 coins of value 0.2, 400 coins of value 0.5, 200 coins of value 0.8, 25 coins of value 1, 20 coins of value 1.5, 5 coins of value 2, 3 coins of value 5, 2 coins of value 10, and 1 coin of value 25. The draw module 476 can then randomly (uniformly) distribute the values of coins in the first list. If the second token values distribution for non-paying cells includes any fixed coins, then the draw module populates the second empty list with coin values of the fixed coins and the quantity of each type (value) of fixed coin. Afterwards, if the second list is not full, the draw module 476 can draw a quantity of wilds to include the in the second list. Based on the distribution DN1 and DN2 above, the probability of the draw module 476 drawing zero wilds is 5%, drawing one wild is 15% and drawing two wilds is 85%. Afterwards, if the second list is not full, the draw module 476 can draw a quantity of coins needed to fill the second list. Based on the distribution DN1, the draw module 476 can draw coins without replacement from a set of coins including 200 coins of value 0.1, 200 coins of value 0.2, 200 coins of value 0.5, 200 coins of value 0.8, 100 coins of value 1, 50 coins of value 1.5, 40 coins of value 2, 6 coins of value 5, 3 coins of value 10, and 1 coin of value 25. Alternatively, if the distribution DN2 was selected, the draw module 476 can draw coins without replacement from a set of coins including 100 coins of value 0, 100 coins of value 0.1, 200 coins of value 0.2, 200 coins of value 0.5, 200 coins of value 0.8, 100 coins of value 1, 50 coins of value 1.5, 40 coins of value 2, 6 coins of value 5, 3 coins of value 10, and 1 coin of value 25. The draw module 476 can then randomly (uniformly) distribute the values of coins in the second list. The bags of coins discussed in this description can comprise virtual bags of coins stored in the data structure 359 or elsewhere in the memory 114.

The use of separate distribution lists for paying cells and non-paying cells allows for putting more hits (i.e., weight) in high value coins when it is known coins will be drawn with the state “coin” and the state “IsPayCell?” false. This allows for controlling the RTP as well as showing greater “near wins.” That use also allows for putting more hits (i.e., weight) in low value coins when it is known coins will be drawn with the state “coin” and the state “IsPayCell?” true. This allows for controlling the RTP.

Next, block 557 includes drawing special symbol positions. The draw module 476 can be configured to draw the special symbol positions. The special symbol positions are positions at which a special symbol, for example, the mystery box symbol 627 is to be displayed during the round of game before revealing a coin value overlaid by the mystery box symbol 627. The draw module 476 can be configured to draw the special symbol positions based on drawings from the configuration file stored in the data structure 359. As an example, the draw module 476 can draw to determine a quantity of cells that have a mystery box symbol (e.g., a quantity within the range 0 to 5). As an example, the number hits associated with those quantities of mystery box symbols can be as follows in this form (symbols/hits): (0/250), (1/150), (2/75), (3/20), (4/5), (5/1).

As for the coin symbols, each cell having the coin symbol state can have a weight (e.g., a number of hits) as a function of its value and if it is a paying cell or a non-paying cell. For example, if the cell is a paying cell the (coin value/hits) criteria can be as follows: (0/0), (0.1/0), (0.2/0), (0.5/0), (0.8/0), (1/1,000), (1.5/2,500), (2/5,000), (5/10,000) (25/25,000). On the other example criteria for a non-paying cell can be as follows: (0/50), (0.1/75), (0.2/50), (0.5/15), (0.8/1), (I/O), (1.5/0), (2/0), (5/0) (25/0).

The draw module 476 can then draw cell indexes without replacement using the weight of the cells eligible for being overlaid by the special symbol.

Next, block 558 includes generating a grid. The generate module 477 can be configured to generate the grid. As an example, generating the grid can include writing data into the data structure 359. The data written into the data structure 359 can correspond to drawings performed at blocks 551, 552, 553, 555, 556, 557. As an example, Table N includes data written into the data structure 359 when generating the grid based on FIG. 8. Table N includes a cell identifier, a symbol identifier, and a coin value. A coin value can be associated with a coin upon which the mystery box symbol is to be overlaid within the grid.

TABLE N

| Cell | Symbol | Value |
|---|---|---|
| 0 | Coin | 1.00 |
| 1 | Empty | Null |
| 2 | Mystery box | 5.00 |
| 3 | Wild diamond | Null |
| 4 | Empty | Null |
| 5 | Empty | Null |
| 6 | Minor | Null |
| 7 | Coin | 0.80 |
| 8 | Empty | Null |
| 9 | Empty | Null |
| 10 | Coin | 2.00 |
| 11 | Empty | Null |
| 12 | L5 | Null |
| 13 | Normal wild | Null |
| 14 | Empty | Null |
| 15 | Empty | Null |
| 16 | Coin | 1.50 |
| 17 | Coin | 0.10 |
| 18 | Empty | Null |
| 19 | Mini | Null |
| 20 | Coin | 0.50 |
| 21 | Empty | Null |
| 22 | Empty | Null |
| 23 | Coin | 5.00 |
| 24 | Empty | Null |
| Null | Null | Null |

Next, block 559 includes drawing a base game feature. The draw module 476 can be configured to draw the base game feature. The draw module 476 can refer to the configuration file within the data structure 359 when performing the base game feature drawing. As an example, the base game feature drawing can indicate “No Feature,” “Respin” or “Power-up.” In accordance with at least some embodiments, if the base game feature drawing is “No Feature,” then no intermediate grid needs to be generated. On the other hand, if the “Respin” or “Power-up” feature is drawn, then an intermediate grid can be generated within the data structure 359. As an example, a set of criteria for drawing the base game feature can be as follows in the form (value/hits): (No Feature/98), (Respin/1), (Power-up/1). In accordance with that example, there is one percent chance the Respin feature is selected, a one percent chance the Power-up feature is selected, and a ninety-eight percent chance No Feature is selected. Other example criteria for selecting the base game feature are possible.

As an example, Table O includes data written into the data structure 359 as part of generating an intermediate grid after the respin and power-up features have been drawn. Comparing the data in Table N to the data in Table O, the value of the coin covered by the mystery box in cell 2 is reduced to 2.00 and the value of the coin in cell 23 is reduced to 0.80 so that performing the power-up feature result in the coins in cell 2 and cell 23 to have values of 2.00 and 5.00, respectively. Also, in Table O, cells 10 and 16 are changed to the empty state so that performing the respin feature results in those cells having coins as indicated in Table N.

TABLE O

| Cell | Symbol | Value |
|---|---|---|
| 0 | Coin | 1.00 |
| 1 | Empty | Null |
| 2 | Mystery box | 2.00 |
| 3 | Wild diamond | Null |
| 4 | Empty | Null |
| 5 | Empty | Null |
| 6 | Minor | Null |
| 7 | Coin | 0.80 |
| 8 | Empty | Null |
| 9 | Power-up wild | Null |
| 10 | Empty | Null |
| 11 | Empty | Null |
| 12 | L5 | Null |
| 13 | Normal wild | Null |
| 14 | Empty | Null |
| 15 | Respin wild | Null |
| 16 | Empty | Null |
| 17 | Coin | 0.10 |
| 18 | Empty | Null |
| 19 | Mini | Null |
| 20 | Coin | 0.50 |
| 21 | Empty | Null |
| 22 | Empty | Null |
| 23 | Coin | 0.80 |
| 24 | Empty | Null |
| Null | Null | Null |

Next, block 560 includes processing base game features. The process feature module 479 can be configured to process the base game features. As an example, a processor executing the process feature module 479 or otherwise can cause the display output module 474 to output animation(s) to represent performance of a base game feature.

As an example, the display output module 474 can output an animation to show empty cells respinning for the respin feature such that cells that are to result in displaying a coin or wild symbol display such coin or wild symbol after the respin. As an example, before processing the respin, the grid 602 can be populated with symbols based on data in Table O and after processing the respin, the grid can be populated with symbols based on data in Table N.

As another example, the display output module 474 can output an animation to show values of coins increasing as a result of performing a power-up. For instance, before processing the power-up, the grid 602 can be populated with coins based on data in Table O and after processing the power-up, the grid can be populated with symbols based on data in Table N.

Next, block 561 includes calculating a grid payout. As an example, the grid payout can be based on coins within completed pay patterns in the grid 602 shown in FIG. 7. The calculate module 478 can be configured to calculate the grid payout.

Next, block 562 includes drawing if wheel is triggered. The draw module 476 can be configured to draw a number indicating whether the wheel is triggered. As an example, a processor executing the draw module 476 or otherwise can determine whether a particular symbol (e.g., a diamond wild symbol) is output within the grid 602. If the particular symbol is not output within the grid 602, the processor can determine that the wheel is not triggered. On the other hand, if the particular symbol is output within the grid 602, the processor executing the draw module 476 or otherwise can refer to the configuration file stored in the data structure 359 to determine criteria for determining whether the wheel is triggered. As an example, the criteria can be based on the grid stats determined at block 554, such as TokensQty, PayTokensQty, and PaylinesQty and whether the state of the game is free spin or note. As an example, criteria for drawing the wheel feature in the form of (value/hits criteria) can be as follows: (Multiplier ×2/400), (Multiplier X3/400), (Multiplier ×5/3,000), (Multiplier ×10/5,000), (Collect/10,000), (Wild Rain/10,000), Major Jackpot/10,359), (Mega Jackpot/1,003). If the TokensQty, PayTokensQty, and PaylinesQty criteria is met, then the probability of drawing Multiplier ×2 is approximately 1%, drawing Multiplier ×3 is approximately 1%, drawing Multiplier ×5 is approximately 7%, drawing Multiplier ×10 is approximately 12%, drawing Collect is approximately 25%, drawing Wild Rain is approximately 25%, drawing Major is approximately 26%, and drawing Mega is approximately 2%.

Next, block 563 includes determining whether wheel is triggered. The draw module 476 can be configured to make that determination.

If a processor executing the draw module 476 or otherwise determines the wheel is triggered, then a flow instruction 571 indicates to go to flow instruction 574 in FIG. 27B. The flow instruction 574 leads to block 564 described below.

On the other hand, if the processor executing the draw module 476 or otherwise determines the wheel is not triggered, then a flow instruction 572 indicates to go to flow instruction 575 in FIG. 27B. The flow instruction 575 leads to block 568 described below.

Next, block 564 includes drawing a wheel feature. The draw module 476 can be configured to draw the wheel feature. As an example, the drawn wheel feature can be any wheel feature defined for a wheel, such as the wheel 603 shown in FIG. 7. In accordance with at least some embodiments, the wheel features can include the multiplier feature, the collect feature, the wild rain feature, and the free spin feature. As noted elsewhere, the multiplier feature can include a times 2 (i.e., ×2) multiplier, a times 3 (i.e., ×3) multiplier, a times 5 (i.e., ×5) multiplier, and a times 10 (i.e., ×10) multiplier. The wheel features can also include a jackpot feature, such as the major jackpot feature and the mega jackpot feature. Other quantities of jackpot features can be defined for the wheel, such as 0, 1, 3, or more than 3 jackpot features. In some embodiments, the wheel can include multiple wheel positions for a single jackpot feature (e.g., multiple wheel positions for the major jackpot feature). The jackpot features can correspond to different jackpot values, such as a first jackpot value for the major jackpot and a second jackpot value for the mega jackpot. The second jackpot value can be larger than the first jackpot value. Names besides, or in addition to, major jackpot and mega jackpot may be defined for the game. By reading this description, a person having ordinary skill in the art will understand that the example games can include jackpot features defined for the wheel 603 and/or jackpot features defined for the grid 602. As an example, the jackpot features defined for the grid 602 can include selecting the minor symbol 625 and/or the mini symbol 626 to determine a jackpot has been won or displaying the minor symbol 625 and/or the mini symbol 626 to indicate a jackpot has been won, either or both without the need to select a position on the wheel 603 to spin the wheel 603.

As an example, the wheel features can correspond to an integer as shown in Table P. The draw module 476 can be configured to draw the wheel feature by calling an RNG to draw an integer from the range 0 to 7. The integers can be weighted to allow the game to have a desired RTP.

TABLE P

| Wheel feature | Integer |
|---|---|
| Multiplier X2 | 0 |
| Multiplier X3 | 1 |
| Multiplier X5 | 2 |
| Multiplier X10 | 3 |
| Collect | 4 |
| Wild Rain | 5 |
| Mega Jackpot | 6 |
| Major Jackpot | 7 |

Next, block 565 includes processing the wheel feature. The process feature module 479 can be configured to process the wheel feature (e.g., the wheel feature drawn at block 564 if the wheel feature is a multiplier feature). Processing the multiplier feature can include the process feature module 479 determining one or more empty cells that are to be filed with a respective wild symbol to create one or more completed pay patterns. In accordance with at least some embodiments, that processing occurs if no completed pay patterns exist. After the process feature module 479 determines the one or more empty cells to be filed with a respective wild symbol, the process feature module 479 can call the calculate module 478 to recalculate at least some of the board stats determined at block 554. Additionally, the process feature module 479 can be configured to call the display output module 474 to cause the display to display the additional wild symbol(s).

Next, block 566 includes processing a feature power-up. The process feature module 479 can be configured to process the feature power-up. As an example, the feature power-up can be processed if the wheel feature drawn at block 564 corresponds to a power-up feature, such as the multiplier feature, the collect feature, or the wild rain feature.

As an example, the process feature module 479 can be configured to draw, or to call the draw module 476 to draw, a quantity of cells that will power-up. If the wheel feature drawn at block 564 is a multiplier feature, then the quantity of cells that will power-up can range from 1 to the quantity of cells with coins that will be paying (e.g., the PaycellsQty referenced above). If the wheel feature drawn at block 564 is the collector or wild rain feature, then the quantity of cells that will power-up can range from 1 to the quantity of cells with coins that will be paying (e.g., the PaycellsQty referenced above).

Next, the process feature module 479 can be configured to draw, or to call the draw module 476 to draw, the indexes of the grid cells that will have power-up. In accordance with at least some embodiments, the grid cells can be selected uniformly among the cells eligible for power-up.

Next, the process feature module 479 can be configured to draw, or to call the draw module 476 to draw, a quantity of levels (e.g., a multiplier) that the coins within the drawn cells will increase. For example, the quantity of levels can be 3 such that a coin having a value of 0.5 is increased to a value of 1.5. In accordance with at least some embodiments, the quantities of levels drawn can be the same for all coins that will have values increased. Alternatively, different quantities of levels can be drawn for two more coins that will have values increased.

Execution of the process feature module 479 to perform the power-up can result in modifying data, indexed to grid cells, with the increased value of coins that were powered-up. An example of modifying such data can be seen by comparing the data in Table N and Table O.

Next, block 567 includes calculating a wheel feature payout. As an example, the wheel feature payout can be based on actions carried out by processing the wheel feature and the wheel feature power-up if processed. The calculate module 478 can be configured to calculate the wheel feature payout. As an example, the calculate module 478 can read the memory 114 to determine a value indicated by the jackpot indicator 649 if processing the wheel feature results in the mega symbol stopping at the pointer 663, or a value indicated by the jackpot indicator 650 if processing the wheel feature results in the major symbol stopping at the pointer 663.

Next, block 568 includes calculating a free spins quantity. The calculate module 478 can be configured to calculate the free spins quantity. As an example, the calculate module 478 can be configured to read the board stats determined at block 554 to determine a quantity of diamond symbols drawn to be output on the display using a diamond wild symbol. As an example, if the quantity of drawn diamond symbols equals 3, 4, or 5, then the quantity of frees spins is 10, 15, or 20 free spins, respectively. As another example, if the quantity of drawn diamond symbols equals 0, 1, or 2, then the quantity of frees spins is 1, 3, or 5 free spins, respectively. As an example, the quantity of spins to be awarded are read from within the program instructions 351 or from within a configuration file of the data structure 359.

Next, block 569 includes updating a free spins counter. The process feature module 479 can be configured to update the free spins counter, such as a free spins counter within the counter 360. As an example, the process feature module 479 can be configured to add the free spins quantity determined at block 568 to a current quantity of free spins indicated by the free spins counter.

Next, block 570 includes determining a game state. The game state module 580 can be configured to determine the game state at block 570. As an example, the game state module 580 can be configured to determine game states for a next round of the game. The game states for the next round of the game can include game stats for the game board, such as a free spin counter output on the display. As example, determining the game states for the next round of the game can include updating a free spin counter (e.g., decrement the free spin counter).

If a free spins counter equals zero, then the next round of the game is a betting round (i.e., a bet is required to perform the next round of the game). Game context, such as free trigger can be set to zero and triggered wheels can be set to zero. This game state for a betting round can be referred to as a “paid spin state.”

If a free spins counter is greater than zero, then the next round of the game is a free spin such that a bet is not required to perform the next round of the game. This game state can be referred to as a “free spin state.” If the wheel was triggered at block 563, then a triggered wheel counter is incremented by one. If any free spins are awarded at block 568, then a free spins trigger counter is incremented by one.

In accordance with at least some embodiments, a game that implements the triggered wheel counter may have one or more counter thresholds defined for the game. Reaching a counter threshold with respect to the triggered wheels counter can trigger a particular feature to be performed (e.g., outputting an animation showing the wheel spinning) or enabling a particular feature (e.g., enabling a particular jackpot (e.g., the major or mega jackpot). As an example, enabling the particular feature can include selecting selection criteria that allows the particular feature to be selected. As an example, each counter threshold corresponding to the triggered wheel counter can include a value such as 0, 1, 2, 3 or some other value.

In accordance with at least some embodiments, a game that implements the free spins trigger counter may have one or more counter thresholds defined for the game. Reaching a counter threshold with respect to the free spins trigger counter can trigger a particular feature to be performed (e.g., entering a mode to perform free spins of the game) or enabling a particular feature (e.g., enabling awarding of free spins). As an example, enabling the particular feature can include selecting selection criteria that allows the particular feature to be selected. As an example, each counter threshold corresponding to the free spins trigger counter can include a value such as 0, 1, 2, 3 or some other value.

After determining the game state at block 570, the method proceeds at flow instruction 576 which indicates to go to flow instruction 573 in FIG. 27A. The flow instruction 573 leads to block 551.

### VI. Conclusions

While one or more disclosed functions have been described as being performed by a machine (e.g., the machine 50) or a computing system (e.g., the computing system 51, 100, 100A, 100B), one or more of the functions can be performed by other computing system(s) as well. Also, while this disclosure includes examples in which the computing system 100A performs select functions and sends data to the computing system 100B, such that the computing system 100B can perform complementing functions and receive the data, variations to those functions can be made while adhering to the general server-client topology and the scope of the disclosed machines, computing systems, and methods.

For example, rather than the computing system 100A sending select data (e.g., a symbol set) to the computing system 100B, such that the computing system 100B can generate and display appropriate images, the computing system 100A can generate the images, animations, or GUIs and send them to the computing system 100B for display. Indeed, it will be appreciated by one of ordinary skill in the art that the “break point” between the server computing system's functions and the client computing system's functions can be varied.

Furthermore, the functions described throughout this can be performed in an order different than an order of functions (if any) described herein or shown in the drawings. Additionally, embodiments in the form of a method can include one or more of the functions described herein or shown in the drawings.

Furthermore still, while examples have been described in terms of select embodiments, alterations and permutations of these embodiments will be apparent to those of ordinary skill in the art. Other changes, substitutions, and alterations are also possible without departing from the disclosed machines, computing systems, and methods in their broader aspects as set forth in the claims following this section.

Finally, one or more embodiments described above may relate to one or more of the following enumerated example embodiments (EEE).

EEE 1 is a method comprising: outputting, on a display, a virtual game board, the virtual game board including a grid with multiple cells indexed to respective cell positions within the grid, each cell being adapted to display a symbol corresponding to a state of the cell determined for a round of a game; initiating, within a computer-readable memory, a data structure to contain initial game data for the round of the game to be displayed on the virtual game board; performing multiple drawings using a random number generator to determine a tokens quantity, a first token-type quantity, a second token-type quantity, and cell positions within the grid for placement of a quantity of symbols equal to the tokens quantity; performing the first token-type quantity of drawings and the second token-type quantity of drawings to determine new states of at least some of the multiple cells; generating, within the data structure, modified data corresponding to the round of the game based on the multiple drawings and the new states of at least some of the multiple cells, the modified data indicating a set of symbols and corresponding cell positions where to display the set of symbols during performance of the round of the game; determining a board payout based on the modified data; outputting, within the virtual game board on the display, an animation representing a respective reel spinning in at least some of the multiple cells until the respective reel stops to display the symbol corresponding to the state of the cell determined for the round of the game; and providing the board payout.

EEE 2 is the method of EEE 1, wherein: performing the multiple drawings occurs sequentially including performing a first drawing to determine the tokens quantity, then performing a second drawing to determine the first token-type quantity, and then performing a quantity of drawings equal to the tokens quantity to determine the cell positions, and determining the second token-type quantity includes determining a difference between the tokens quantity and the first token-type quantity.

EEE 3 is the method of any one of EEE 1 or 2, further comprising: determining first and second criteria for the round of the game, wherein: performing the first drawing is based on the first criteria, performing the second drawing is based on second criteria, and determining the second criteria is conditioned on the tokens quantity determined by performing the first drawing.

EEE 4 is the method of EEE 3, wherein determining the first and second criteria includes reading a computer-readable configuration file containing the first and second criteria for the round of the game.

EEE 5 is the method of any one of EEE 3 or 4, wherein the first criteria indicates whether the round of the game is a free round, and whether quantities of tokens available for determining by the first drawing are weighted.

EEE 6 is method of any one of EEE 1 to 5, wherein the tokens quantity indicates a quantity within a range of whole numbers greater than zero and less than a number equal to a total quantity of cells within the grid.

EEE 7 is the method of EEE 6, wherein the total quantity of cells is greater than or equal to 9.

EEE 8 is the method of EEE 7, wherein the total quantity of cells equals 25.

EEE 9 is the method of EEE 8, wherein the range of whole numbers includes two or more numbers selected from a group of numbers consisting of 11, 12, 13, 14, 15, 16, and 17.

EEE 10 is the method of EEE 9, wherein the two or more numbers are consecutive numbers.

EEE 11 is the method of any one of EEE 1 to 10 further comprising: calculating one or more board statistics.

EEE 12 is the method of EEE 11, wherein the one or more board statistics includes a statistic indicating a quantity of completed pay patterns within the grid.

EEE 13 is the method any one of EEE 11 to 12, wherein the one or more board statistics includes a statistic indicating a quantity of coin symbols that will result in a pay-out.

EEE 14 is the method any one of EEE 11 to 13, wherein the one or more board statistics includes a statistic indicating a quantity of cells with coin symbols that will be paying with repetition.

EEE 15 is the method of any one of EEE 1 to 14, further comprising: performing a drawing using the random number generator to determine a tokens values distribution.

EEE 16 is the method of EEE 15, wherein the tokens value distribution is contained within a computer-readable configuration file.

EEE 17 is the method of EEE 16, wherein the configuration file includes multiple tokens value distribution for paying cells, and multiple tokens value distribution for non-paying cells.

EEE 18 is the method of EEE 17, wherein the configuration file includes first criteria for selecting a first tokens value distribution from the multiple tokens value distribution for paying cells, and second criteria for selecting a second tokens value distribution from the multiple tokens value distribution for non-paying cells.

EEE 19 is the method of EEE 18, wherein the first criteria and the second criteria include one or more of the following criterion: a tokens quantity criterion, a pay tokens quantity criterion, a pay lines quantity criterion, a free spin state criterion, and a diamonds quantity criterion.

EEE 20 is the method of any one of EEE 17 to 19, wherein each tokens value distribution of the multiple tokens value distribution for paying cells corresponds to a first respective distribution probability from a first set of distribution probabilities, and wherein each tokens value distribution of the multiple tokens value distribution for non-paying cells corresponds to a second respective distribution probability from a second set of distribution probabilities.

EEE 21 is the method of EEE 20, wherein a sum of the first set of distribution probabilities equals one, and a sum of the second set of distribution probabilities equals one.

EEE 22 is the method of any one of EEE 14 to 21, wherein the first tokens value distribution and/or the second tokens value distribution includes multiple fixed coins values and corresponding fixed coin quantity values.

EEE 23 is the method of any one of EEE 14 to 22, wherein the first tokens value distribution and/or the second tokens value distribution includes multiple wilds quantity values and corresponding probability values.

EEE 24 is the method of any one of EEE 14 to 23, wherein the first tokens value distribution and/or the second tokens value distribution includes multiple coin values and corresponding hits values.

EEE 25 is the method of any one of EEE 11 to 24, further comprising: performing a drawing, from the determined tokens value distribution using the random number generator, to determine a quantity of coin values, wherein the quantity of coin values equals the first tokens-type quantity, the second token-type quantity, the first tokens quantity minus the second tokens quantity, or the second tokens-type quantity minus the first tokens-type quantity.

EEE 26 is method of any one of EEE 1 to 25, further comprising: performing a drawing using the random number generator to determine a base game feature to trigger outputting an additional animation for the round of the game, wherein: the symbol corresponding to the state of a particular cell determined for the round of the game is a preliminary symbol, and the method further includes outputting, within the virtual game board on the display, the additional animation to represent a respective reel spinning in the particular cell until the respective reel in the particular cell stops to display a final symbol corresponding to the state of cell determined for the round of the game.

EEE 27 is method of any one of EEE 1 to 26, wherein initiating the data structure includes setting a state for each indexed cell to an empty state.

EEE 28 is method of any one of EEE 1 to 26, wherein initiating the data structure includes setting a state for one particular indexed cell state to a free space state and a state for each indexed cell except for one particular indexed cell to an empty state.

EEE 29 is method of any one of EEE 1 to 28, wherein the data structure includes an extensible markup language (XML) file containing user session data.

EEE 30 is the method of EEE 29, wherein the XML file includes: an integer list comprising a cell index value corresponding to each cell of the multiple cells, an integer list comprising symbol identifiers corresponding to each cell index value, and a decimal list comprising a value for each cell index value.

EEE 31 is method of any one of EEE 1 to 30, wherein determining the second token-type quantity includes determining a difference between the tokens quantity and the first token-type quantity.

EEE 32 is the method of any one of EEE 1 to 30, wherein determining the first token-type quantity includes determining a difference between the tokens quantity and the second token-type quantity.

EEE 33 is method of any one of EEE 1 to 32, wherein the grid with multiple cells includes a first quantity rows and a second quantity columns.

EEE 34 is the method of EEE 33, wherein the first quantity does not equal the second quantity.

EEE 35 is the method of EEE 33, wherein the first quantity equals the second quantity.

EEE 36 is the method of EEE 35, wherein: the first quantity and the second quantity both equal five, and the grid with multiple cells includes a rectangular grid and twenty-five cell positions corresponding to a respective cell position of the multiple indexed cells.

EEE 37 is the method of EEE 36, wherein the grid includes five horizontal paylines, five vertical paylines, and two diagonal paylines, each of which includes a different combination of five cell positions.

EEE 38 is the method of any one of EEE 33 to 37, wherein the grid includes multiple pay patterns.

EEE 39 is the method of EEE 38, wherein one or more of the multiple pay patterns includes a horizontal payline, a vertical payline, a diagonal payline, a cluster of adjacent cells, a cluster of non-adjacent cells, and a partially vertical and partially horizontal pattern.

EEE 40 is the method of EEE 39, wherein the horizontal payline comprises contiguous cells extending from a top of the grid to a bottom of the grid.

EEE 41 is the method of any one of EEE 39 or 40, wherein the vertical payline comprises contiguous cells extending from a left side of the grid to a right side of the grid.

EEE 42 is the method of any one of EEE 39 to 41, wherein the diagonal payline comprises contiguous cells extending from a top, left side of the grid to a bottom, right side of the grid or from a top, right side of the grid to a bottom, left side of the grid.

EEE 43 is the method of any one of EEE 39 to 42, wherein the partially vertical and partially horizontal pattern comprises a T-shaped pattern or an X-shaped pattern.

EEE 44 is method of any one of EEE 1 to 43, wherein performing the multiple drawings further includes using the random number generator to determine a base game feature state selected from the group consisting of: a no base game feature state, a respin base game feature state, and a power-up base game feature state.

EEE 45 is method of any one of EEE 1 to 44, wherein the new states of at least some of the multiple cells correspond to a token value or a type of wild symbol.

EEE 46 is method of any one of EEE 1 to 45, wherein: the display comprises a touch screen display, the method further comprises: outputting, on the display, a user-selectable control while the virtual game board is output on the display; receiving, with a processor at the client device, an input signal indicating a contact with the display occurs where the user-selectable control is output on the display; launching, within the processor in response to determining the contact with the display occurs, an executable module for initiating the data structure.

EEE 47 is the method of any one of EEE 1 to 46, further comprising calculating a grid payout.

EEE 48 is the method of any one of EEE 1 to 47, further comprising determining whether a wheel is triggered by performing a drawing using the random number generator.

EEE 49 is the method of EEE 48, wherein the wheel is triggered, and wherein the method further comprises determining a wheel feature by drawing the wheel feature using the random number generator.

EEE 50 is the method of EEE 49, wherein the wheel feature is selected from the group consisting of a multiplier, a collect feature, a wild rain feature, and a jackpot feature.

EEE 51 is the method of EEE 50, wherein the multiplier is selected from the group consisting of a 2× multiplier, a 3× multiplier, a 5× multiplier, and a 10× multiplier.

EEE 52 is the method of any one of EEE 50 to 51, wherein the jackpot feature is a first jackpot or a second jackpot, and wherein the first jackpot is larger than the second jackpot.

EEE 53 is the method of any one of EEE 49 to 52, further comprising performing the wheel feature.

EEE 54 is the method of EEE 53, further comprising performing a wheel feature payout.

EEE 55 is the method any one of EEE 1 to 54, further comprising: calculating a quantity of free spins.

EEE 56 is the method of EEE 55, further comprising updating a free spins counter.

EEE 57 is method of any one of EEE 1 to 56, wherein: the display comprises a touch screen display at a client device, the method further comprises: outputting, on the display, a user-selectable control while the virtual game board is output on the display; receiving, with a processor at the client device, an input signal indicating a contact with the display occurs where the user-selectable control is output on the display; launching, within the processor at the client device in response to determining the contact with the display occurs, an executable module to transmit to a server a request to perform the round of the game; and launching, within a processor at the server in response to receiving the request, a module for initiating the data structure.

EEE 58 is a computing system comprising: one or more processors; and non-transitory computer-readable memory storing executable instructions, wherein execution of the instructions by the one or more processors causes the computing system to perform the following functions: outputting, on a display, a virtual game board, the virtual game board including a grid with multiple cells indexed to respective cell positions within the grid, each cell being adapted to display a symbol corresponding to a state of the cell determined for a round of the game; initiating, within a computer-readable memory, a data structure to contain initial game data for the round of the game to be displayed on the virtual game board; performing multiple drawings using a random number generator to determine a tokens quantity, a first token-type quantity, a second token-type quantity, and cell positions within the grid for placement of a quantity of symbols equal to the tokens quantity; performing the first token-type quantity of drawings and the second token-type quantity of drawings to determine new states of at least some of the multiple cells; generating, within the data structure, modified data corresponding to the round of the game based on the multiple drawings and changes to the states of at least some of the multiple cells, the modified data indicating a set of symbols and corresponding cell positions where to display the set of symbols during performance of the round of the game; determining a board payout based on the modified data; outputting, within the virtual game board on the display, an animation representing a respective reel spinning in at least some of the multiple cells until the respective reel stops to display a symbol corresponding to a state of cell determined for the round of the game; and providing the board payout.

EEE 59 is a computing system comprising: one or more processors, and non-transitory computer-readable memory storing executable instructions, wherein execution of the executable instructions by the one or more processors causes the computing system to perform the method of any one of EEE 1-57.

EEE 60 is non-transitory computer-readable memory having stored therein instructions executable by one or more processors to cause a computing system to perform functions comprising: outputting, on a display, a virtual game board, the virtual game board including a grid with multiple cells indexed to respective cell positions within the grid, each cell being adapted to display a symbol corresponding to a state of the cell determined for a round of the game; initiating, within a computer-readable memory, a data structure to contain initial game data for the round of the game to be displayed on the virtual game board; performing multiple drawings using a random number generator to determine a tokens quantity, a first token-type quantity, a second token-type quantity, and cell positions within the grid for placement of a quantity of symbols equal to the tokens quantity; performing the first token-type quantity of drawings and the second token-type quantity of drawings to determine new states of at least some of the multiple cells; generating, within the data structure, modified data corresponding to the round of the game based on the multiple drawings and changes to the states of at least some of the multiple cells, the modified data indicating a set of symbols and corresponding cell positions where to display the set of symbols during performance of the round of the game; determining a board payout based on the modified data; outputting, within the virtual game board on the display, an animation representing a respective reel spinning in at least some of the multiple cells until the respective reel stops to display a symbol corresponding to a state of cell determined for the round of the game; and providing the board payout.

EEE 61 is non-transitory computer-readable memory having stored therein instructions executable by one or more processors to cause a computing system to perform the method of any one of EEE 1-57.

1. A method comprising:
outputting, on a display, a virtual game board, the virtual game board including a grid with multiple cells indexed to respective cell positions within the grid, each cell being adapted to display a symbol corresponding to a state of the cell determined for a round of the game;
initiating, within a computer-readable memory, a data structure to contain initial game data for the round of the game to be displayed on the virtual game board;
performing multiple drawings using a random number generator to determine a tokens quantity, a first token-type quantity, a second token-type quantity, and cell positions within the grid for placement of a quantity of symbols equal to the tokens quantity;
performing the first token-type quantity of drawings and the second token-type quantity of drawings to determine new states of at least some of the multiple cells;
generating, within the data structure, modified data corresponding to the round of the game based on the multiple drawings and the new states of at least some of the multiple cells, the modified data indicating a set of symbols and corresponding cell positions where to display the set of symbols during performance of the round of the game;
determining a board payout based on the modified data;
outputting, within the virtual game board on the display, an animation representing a respective reel spinning in at least some of the multiple cells until the respective reel stops to display the symbol corresponding to the state of the cell determined for the round of the game; and
providing the board payout.

2. The method of claim 1, wherein:
performing the multiple drawings occurs sequentially including performing a first drawing to determine the tokens quantity, then performing a second drawing to determine the first token-type quantity, and then performing a quantity of drawings equal to the tokens quantity to determine the cell positions, and
determining the second token-type quantity includes determining a difference between the tokens quantity and the first token-type quantity.

3. The method of claim 1, further comprising:
determining first and second criteria for the round of the game, wherein:
performing the first drawing is based on the first criteria,
performing the second drawing is based on second criteria, and
determining the second criteria is conditioned on the tokens quantity determined by performing the first drawing.

4. The method of claim 3, wherein determining the first and second criteria includes reading a computer-readable configuration file containing the first and second criteria for the round of the game.

5. The method of claim 3, wherein the first criteria indicates whether the round of the game is a free round, and whether quantities of tokens available for determining by the first drawing are weighted.

6. The method of claim 1, further comprising:
performing a drawing using the random number generator to determine a base game feature to trigger outputting an additional animation for the round of the game, wherein:
the symbol corresponding to the state of a particular cell determined for the round of the game is a preliminary symbol, and
the method further includes outputting, within the virtual game board on the display, the additional animation to represent a respective reel spinning in the particular cell until the respective reel in the particular cell stops to display a final symbol corresponding to the state of cell determined for the round of the game.

7. The method of claim 1, wherein initiating the data structure includes setting a state for each indexed cell to an empty state.

8. The method of claim 1, wherein initiating the data structure includes setting a state for one particular indexed cell state to a free space state and a state for each indexed cell except for one particular indexed cell to an empty state.

9. The method of claim 1, wherein the data structure includes an extensible markup language (XML) file containing user session data.

10. The method of claim 9, wherein the XML file includes:
an integer list comprising a cell index value corresponding to each cell of the multiple cells,
an integer list comprising symbol identifiers corresponding to each cell index value, and
a decimal list comprising a value for each cell index value.

11. The method of claim 1, wherein determining the second token-type quantity includes determining a difference between the tokens quantity and the first token-type quantity.

12. The method of claim 1, wherein the grid with multiple cells includes a first quantity rows and a second quantity columns.

13. The method of claim 12, wherein the first quantity does not equal the second quantity.

14. The method of claim 12, wherein the first quantity equals the second quantity.

15. The method of claim 12, wherein the grid includes multiple pay patterns.

16. The method of claim 15, wherein one or more of the multiple pay patterns includes a horizontal payline, a vertical payline, a diagonal payline, a cluster of adjacent cells, a cluster of non-adjacent cells, and a partially vertical and partially horizontal pattern.

17. The method of claim 1, wherein performing the multiple drawings further includes using the random number generator to determine a base game feature state selected from the group consisting of: a no base game feature state, a respin base game feature state, and a power-up base game feature state.

18. The method of claim 1, wherein the new states of at least some of the multiple cells correspond to a token value or a type of wild symbol.

19. The method of claim 1, wherein:
the display comprises a touch screen display,
the method further comprises:
outputting, on the display, a user-selectable control while the virtual game board is output on the display;
determining a contact with the display occurs where the user-selectable control is output on the display;
launching, within a processor in response to determining the contact with the display occurs, an executable module for initiating the data structure.

20. The method of claim 1, wherein:
the display comprises a touch screen display at a client device,
the method further comprises:
outputting, on the display, a user-selectable control while the virtual game board is output on the display;
receiving, with a processor at the client device, an input signal indicating a contact with the display occurs where the user-selectable control is output on the display;
launching, within the processor at the client device in response to determining the contact with the display occurs, an executable module to transmit to a server a request to perform the round of the game; and
launching, within a processor at the server in response to receiving the request, a module for initiating the data structure.

21. A computing system comprising:
one or more processors; and
non-transitory computer-readable memory storing executable instructions, wherein execution of the instructions by the one or more processors causes the computing system to perform the following functions:
outputting, on a display, a virtual game board, the virtual game board including a grid with multiple cells indexed to respective cell positions within the grid, each cell being adapted to display a symbol corresponding to a state of the cell determined for a round of the game;
initiating, within a computer-readable memory, a data structure to contain initial game data for the round of the game to be displayed on the virtual game board;
performing multiple drawings using a random number generator to determine a tokens quantity, a first token-type quantity, a second token-type quantity, and cell positions within the grid for placement of a quantity of symbols equal to the tokens quantity;
performing the first token-type quantity of drawings and the second token-type quantity of drawings to determine new states of at least some of the multiple cells;
generating, within the data structure, modified data corresponding to the round of the game based on the multiple drawings and changes to the states of at least some of the multiple cells, the modified data indicating a set of symbols and corresponding cell positions where to display the set of symbols during performance of the round of the game;
determining a board payout based on the modified data;
outputting, within the virtual game board on the display, an animation representing a respective reel spinning in at least some of the multiple cells until the respective reel stops to display the symbol corresponding to the state of cell determined for the round of the game; and
providing the board payout.

22. Non-transitory computer-readable memory having stored therein instructions executable by one or more processors to cause a computing system to perform functions comprising:
outputting, on a display, a virtual game board, the virtual game board including a grid with multiple cells indexed to respective cell positions within the grid, each cell being adapted to display a symbol corresponding to a state of the cell determined for a round of the game;
initiating, within a computer-readable memory, a data structure to contain initial game data for the round of the game to be displayed on the virtual game board;
performing multiple drawings using a random number generator to determine a tokens quantity, a first token-type quantity, a second token-type quantity, and cell positions within the grid for placement of a quantity of symbols equal to the tokens quantity;
performing the first token-type quantity of drawings and the second token-type quantity of drawings to determine new states of at least some of the multiple cells;
generating, within the data structure, modified data corresponding to the round of the game based on the multiple drawings and changes to the states of at least some of the multiple cells, the modified data indicating a set of symbols and corresponding cell positions where to display the set of symbols during performance of the round of the game;
determining a board payout based on the modified data;
outputting, within the virtual game board on the display, an animation representing a respective reel spinning in at least some of the multiple cells until the respective reel stops to display a symbol corresponding to a state of cell determined for the round of the game; and
providing the board payout.
